(19) United States
(12) Patent Application Publication
(10) Pub. No.: US 2023/0259132 A1
(43) Pub. Date: Aug. 17, 2023

(54) SYSTEMS AND METHODS FOR DETERMINING THE POSITION OF AN OBJECT USING AN UNMANNED AERIAL VEHICLE

(71) Applicant: SZ DJI TECHNOLOGY CO., LTD., Shenzhen (CN)

(72) Inventor: Jie QIAN, Shenzhen (CN)

(73) Assignee: SZ DJI TECHNOLOGY CO., LTD., Shenzhen (CN)

(21) Appl. No.: 18/136,892

(22) Filed: Apr. 20, 2023

Related U.S. Application Data
(63) Continuation of application No. PCT/CN2020/141544, filed on Dec. 30, 2020.

(51) Int. Cl. G05D 1/00; G05D 1/10; B64U 10/00; G06V 20/17; G06T 7/70; H04N 23/695; G06V 20/40; G06V 10/74; H04N 7/18; H04N 23/56

(52) U.S. Cl. CPC G05D 1/0094; G05D 1/101; B64U 10/00; G06V 20/17; G06T 7/70; H04N 23/695; G06V 20/41; G06V 10/74; H04N 7/183; H04N 23/56; B64U 2101/30

(57) ABSTRACT

An unmanned aerial vehicle (UAV) may have a positional sensor and an image sensor. The UAV may receive from an electronic structure a first wireless signal. The first wireless signal may include a first direction of illumination. In accordance with the first wireless signal, the UAV may identify a target object based, at least in part, on the first direction of illumination. The UAV may also determine positional coordinates of the target object.

### CROSS-REFERENCE TO RELATED APPLICATION

The present application is a continuation of International Application No. PCT/CN2020/141544, filed Dec. 30, 2020, which is incorporated herein by reference in its entirety.

### TECHNICAL FIELD

The disclosed embodiments relate generally to target object identification and more specifically, to systems and methods for determining positional information of a target object using unmanned aerial vehicle (UAV) technology.

### BACKGROUND

Movable objects can be used for performing surveillance, reconnaissance, and exploration tasks for military and civilian applications. An unmanned aerial vehicle (UAV) (e.g., a drone) is an example of a movable object. A movable object may carry a payload for performing specific functions such as capturing images and video of a surrounding environment of the movable object or for tracking a specific target (e.g., a target object). For example, a movable object may track a target object that is moving on the ground or in the air. Movement control information for controlling a movable object is typically received by the movable object from a remote device and/or determined by the movable object.

### SUMMARY

The advancement of UAV technology has enabled UAV aerial photography and videography. If a user intends to capture images and/or video of a specific target object using UAV aerial photography and videography, the user will need to provide to the UAV precise positional information of the target object. This may be particularly challenging if the positional information of the target object is not known to the user, and/or if the target object comprises a moving object that does not have fixed positional coordinates.

Accordingly, there is a need for improved systems, devices, and methods for determining position (e.g., positional coordinates) of a target object with ease and accuracy, and for communicating the position of the target object to a UAV, so as to enable the UAV to capture images and/or video of the target object. The various embodiments disclosed herein describe a UAV that is communicatively connected with an electronic device or structure. The UAV receives from the electronic device a wireless signal, and determines the positional coordinates of a target object based at least in part from the received signal. Such systems and methods optionally complement or replace conventional methods for target identification, target tracking, and/or image or video capture.

In accordance with some embodiments of the present disclosure, a method is performed at an unmanned aerial vehicle (UAV) having a positional sensor, an image sensor, one or more processors, and memory. The UAV receives from an electronic device a first wireless signal. The first wireless signal includes a first direction of illumination. In accordance with the first wireless signal, the UAV identifies a target object based, at least in part, on the first direction of illumination. The UAV determines positional coordinates of the target object.

In some embodiments, identifying a target object based, at least in part, on the first direction of illumination further comprises: in accordance with the first wireless signal, the UAV orients the image sensor toward the first direction of illumination. After orienting the image sensor, the UAV captures video data via the image sensor. The UAV determines from the video data the target object. The UAV identifies the target object.

In some embodiments, determining from the video data the target object further comprises: the UAV receives from the electronic device an image that includes the target object. The UAV determines the target object according to a match between objects in the video data and the image.

In some embodiments, determining from the video data the target object includes: the UAV detects a first predefined pattern of illumination in the video data. The UAV identifies an object reflecting the first predefined pattern of illumination as the target object.

In some embodiments, the first predefined pattern of illumination comprises a first temporal frequency.

In some embodiments, the first predefined pattern of illumination comprises a color.

In some embodiments, after determining the positional coordinates of the target object, the UAV receives from the electronic device a second wireless signal. The second wireless signal includes a predefined pattern of illumination having a second temporal frequency, distinct from the first temporal frequency. In response to the second wireless signal, the UAV selects automatically and without user intervention, from a plurality of predefined flight routes, a first flight route for the UAV corresponding to the second temporal frequency. The one or more processors control the UAV to fly autonomously according to the first flight route.

In some embodiments, controlling the UAV to fly autonomously according to the first flight route includes capturing by the image sensor a video feed having a field of view of the image sensor.

In some embodiments, the first wireless signal further includes position information of the electronic device. Determining positional coordinates of the target object further comprises: the UAV determines angle information of the target object relative to the UAV. The UAV extracts, from the first wireless signal, the position information of the electronic device. The UAV determines angle information of the target object relative to the electronic device using the position information of the electronic device. The UAV determines the positional coordinates of the target object using the position information of the electronic device, positional information of the UAV, and the angle information of the target object relative to the electronic device and the UAV.

In some embodiments, determining positional coordinates of the target object further comprises: the UAV receives from the electronic device a third wireless signal. The third wireless signal comprises illumination having a regular and predefined time interval. The third wireless signal includes respective times of the illumination. In response to receiving the third wireless signal, the UAV captures video data of the illumination using the image sensor. The UAV determines, for each illumination, a time difference between the time of illumination and a corresponding video data capture time. The UAV determines, based on the time difference, a distance between the electronic device and the target object and a distance between the UAV and the target object. The UAV determines the positional coordinates of the target object using the distance between the electronic device and the target object, the distance between the UAV and the target object, positional information of the electronic device, and positional information of the UAV.

In some embodiments, prior to receiving the third wireless signal, the UAV synchronizes a clock of the UAV with a clock of the electronic device.

In some embodiments, determining the positional coordinates of the target object further comprises: the UAV queries a map that corresponds to the first direction of illumination. The UAV determines from the map a first object. The UAV assigns the first object as the target object. The UAV determines positional coordinates of the first object. The positional coordinates of the target object are the positional coordinates of the first object.

In some embodiments, the first wireless signal further includes position information of the electronic device and distance information between the electronic device and the target object. The identifying the target object is further based, at least in part, on the position information of the electronic device and the distance information between the electronic device and the target object.

In accordance with another aspect of the present disclosure, a method is performed at an electronic device. The electronic device includes a positional sensor, a light emitter, one or more processors, and memory. The electronic device emits an illumination in a first direction toward a target object. The electronic device determines a distance between the target object and the electronic device based on the illumination. The electronic device transmits to an unmanned aerial vehicle (UAV) a wireless signal. The wireless signal includes the distance between the target object and the electronic device. The wireless signal also includes a current position and orientation of the electronic device. The UAV is configured to orient an image sensor of the UAV towards the target object based on the distance between the target object and the electronic device, and based on the current position and orientation of the electronic device.

In some embodiments, the illumination comprises a predefined pattern of illumination having a first temporal frequency.

In some embodiments, the illumination comprises a predefined pattern of illumination having a first wavelength.

In some embodiments, the electronic device further comprises a camera. The electronic device captures using the camera an image that includes the target object. The electronic device transmits to the UAV the image. The UAV is configured to identify the target object based on matching images of objects captured using the image sensor of the UAV and the image.

In some embodiments, a UAV comprises an image sensor, a distance sensor, one or more processors, memory, and one or more programs stored in the memory. The programs are configured for execution by the one or more processors. The one or more programs include instructions for performing any of the methods described herein.

In some embodiments, an electronic device includes one or more processors, memory, and one or more programs stored in the memory. The one or more programs are configured for execution by the one or more processors. The one or more programs include instructions for performing any of the methods described herein.

In some embodiments, a non-transitory computer-readable storage medium stores one or more programs configured for execution by an unmanned aerial vehicle (UAV) having one or more processors and memory. The one or more programs include instructions for performing any of the methods described herein.

In some embodiments, a non-transitory computer-readable storage medium stores one or more programs configured for execution by an electronic device having one or more processors and memory. The one or more programs include instructions for performing any of the methods described herein.

Thus, methods, systems, and devices are disclosed that enable positional coordinates of a target object to be determined more easily and accurately, thereby facilitating aerial photography and videography using a UAV.

### BRIEF DESCRIPTION OF THE DRAWINGS

For a better understanding of the aforementioned systems, methods, and graphical user interfaces, as well as additional systems, methods, and graphical user interfaces that provide UAV video capture and video editing, reference should be made to the Description of Embodiments below, in conjunction with the following drawings in which like reference numerals refer to corresponding parts throughout the figures.

FIG. 1 illustrates an exemplary target identification and tracking system according to some embodiments.

FIGS. 2A to 2C illustrate respectively, an exemplary movable object, an exemplary carrier of a movable object, and an exemplary payload of a movable object according to some embodiments.

FIG. 3 illustrates an exemplary sensing system of a movable object according to some embodiments.

FIGS. 4A and 4B illustrate a block diagram of an exemplary memory of a movable object according to some embodiments.

FIG. 5 illustrates an exemplary control unit of a target tracking system according to some embodiments.

FIG. 6 illustrates an exemplary computing device for controlling a movable object according to some embodiments.

FIG. 7 illustrates an exemplary configuration of a movable object, a carrier, and a payload according to some embodiments.

FIG. 8 illustrates an exemplary operating environment according to some embodiments.

FIG. 9 is a block diagram illustrating a representative electronic device according to some embodiments.

FIG. 10 illustrates an exemplary method performed by a movable object to determine the positional coordinates of a target object according to some embodiments.

FIG. 11 illustrates exemplary configurations of an electronic device and a movable object 102 for determining a position of a target object according to some embodiments.

FIG. 12 illustrates exemplary methods that a movable object may use to determine a position of a target object, and corresponding information that are provided by the movable object 102, according to some embodiments

FIGS. 13A-13F illustrate a flowchart for a method performed at a UAV according to some embodiments.

FIGS. 14A and 14B illustrate a flowchart for a method performed at an electronic device according to some embodiments.

### DESCRIPTION OF EMBODIMENTS

Reference will now be made in detail to embodiments, examples of which are illustrated in the accompanying drawings. In the following description, numerous specific details are set forth in order to provide a thorough understanding of the present disclosure. However, it will be apparent to one of ordinary skill in the art that the present disclosure may be practiced without requiring these specific details. In other instances, well-known methods, procedures, components, circuits, and networks have not been described in detail so as not to unnecessarily obscure aspects of the embodiments.

The following description uses an unmanned aerial vehicle (UAV) (e.g., a drone) as an example of a movable object. UAVs may include, for example, fixed-wing aircrafts and/or rotary-wing aircrafts such as helicopters, quadcopters, and aircraft having other numbers and/or configurations of rotors. It will be apparent to those skilled in the art that other types of movable objects may be substituted for UAVs as described below in accordance with embodiments of the disclosure.

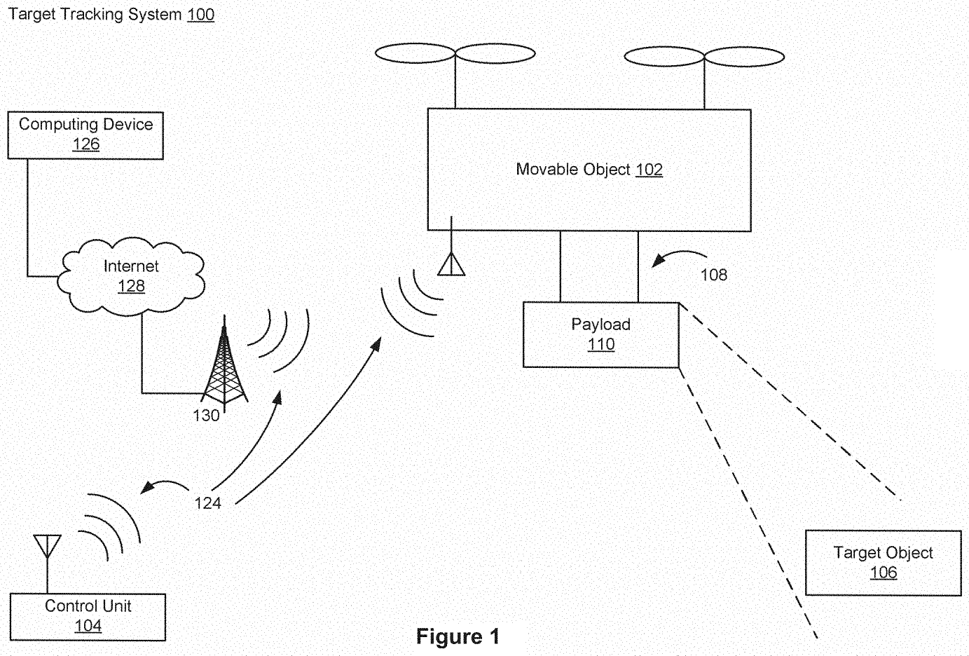

FIG. 1 illustrates an exemplary target identification and tracking system 100 according to some embodiments. The target identification and tracking system 100 includes a movable object 102 (e.g., a UAV) and a control unit 104. In some embodiments, the movable object 102 is also referred to as a movable device (e.g., a movable electronic device). In some embodiments, the target identification and tracking system 100 is used for identifying a target object 106 and/or for initiating tracking of the target object 106.

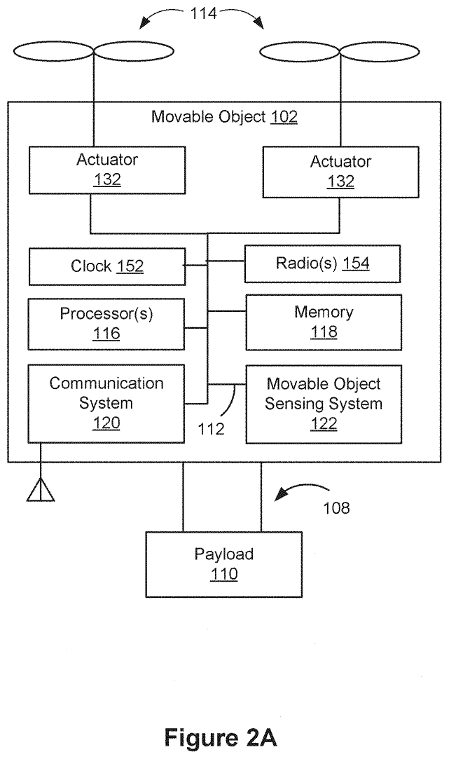

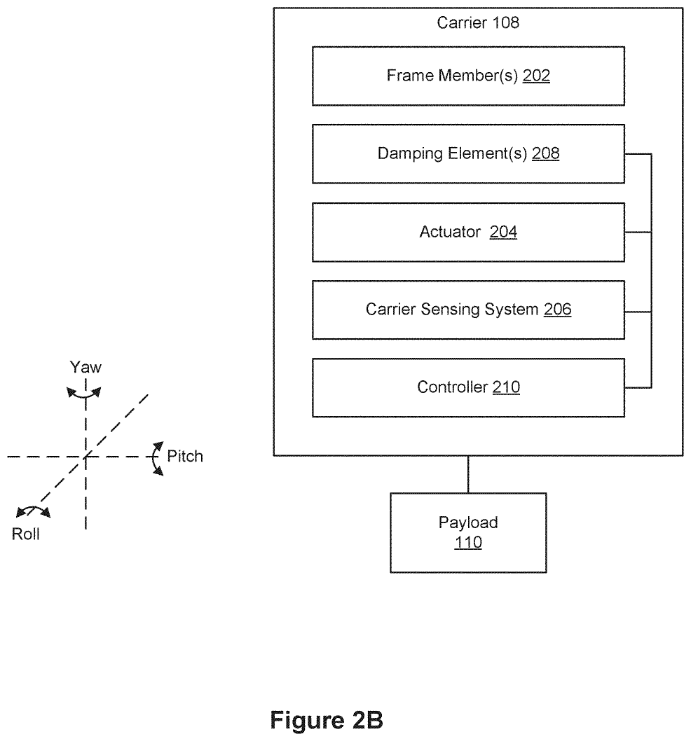

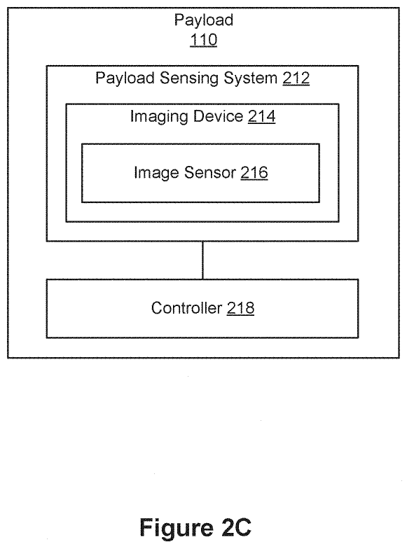

In some embodiments, the target object 106 includes natural and/or man-made objects, such geographical landscapes (e.g., mountains, vegetation, valleys, lakes, and/or rivers), buildings, and/or vehicles (e.g., aircrafts, ships, cars, trucks, buses, vans, and/or motorcycles). In some embodiments, the target object 106 includes live subjects such as people and/or animals. In some embodiments, the target object 106 is a moving object, e.g., moving relative to a reference frame (such as the Earth and/or movable object 102). In some embodiments, the target object 106 is static. In some embodiments, the target object 106 includes an active positioning and navigational system (e.g., a GPS system) that transmits information (e.g., location, positioning, and/or velocity information) about the target object 106 to the movable object 102, a control unit 104, and/or a computing device 126. For example, information may be transmitted to the movable object 102 via wireless communication from a communication unit of the target object 106 to a communication system 120 of the movable object 102, as illustrated in FIG. 2A.

In some embodiments, the movable object 102 includes a carrier 108 and/or a payload 110. The carrier 108 is used to couple the payload 110 to the movable object 102. In some embodiments, the carrier 108 includes an element (e.g., a gimbal and/or damping element) to isolate the payload 110 from movement of the movable object 102. In some embodiments, the carrier 108 includes an element for controlling movement of the payload 110 relative to the movable object 102.

In some embodiments, the payload 110 is coupled (e.g., rigidly coupled) to the movable object 102 (e.g., coupled via the carrier 108) such that the payload 110 remains substantially stationary relative to movable object 102. For example, the carrier 108 may be coupled to the payload 110 such that the payload is not movable relative to the movable object 102. In some embodiments, the payload 110 is mounted directly to the movable object 102 without requiring the carrier 108. In some embodiments, the payload 106 is located partially or fully within the movable object 102.

In some embodiments, the movable object 102 is configured to communicate with the control unit 104, e.g., via wireless communications 124. For example, the movable object 102 may receive control instructions from the control unit 104 (e.g., via a user of the movable object 102) and/or send data (e.g., data from a movable object sensing system 122, FIG. 2A) to the control unit 104.

In some embodiments, the control instructions may include, e.g., navigation instructions for controlling one or more navigational parameters of the movable object 102 such as a position, an orientation, an altitude, an attitude (e.g., aviation) and/or one or more movement characteristics of the movable object 102. In some embodiments, the control instructions may include instructions for controlling one or more parameters of a carrier 108 and/or a payload 110. In some embodiments, the control instructions include instructions for directing movement of one or more of movement mechanisms 114 (FIG. 2A) of the movable object 102. For example, the control instructions may be used to control a flight of the movable object 102. In some embodiments, the control instructions may include information for controlling operations (e.g., movement) of the carrier 108. For example, the control instructions may be used to control an actuation mechanism of the carrier 108 so as to cause angular and/or linear movement of the payload 110 relative to the movable object 102. In some embodiments, the control instructions are used to adjust one or more operational parameters for the payload 110, such as instructions for capturing one or more images, capturing video, adjusting a zoom level, powering on or off a component of the payload, adjusting an imaging mode (e.g., capturing still images or capturing video), adjusting an image resolution, adjusting a focus, adjusting a viewing angle, adjusting a field of view, adjusting a depth of field, adjusting an exposure time, adjusting a shutter speed, adjusting a lens speed, adjusting an ISO, changing a lens and/or moving the payload 110 (and/or a part of payload 110, such as imaging device 214 (shown in FIG. 2C)). In some embodiments, the control instructions are used to control the communication system 120, the sensing system 122, and/or another component of the movable object 102.

In some embodiments, the control instructions from the control unit 104 may include instructions to initiate tracking of a target object 106. For example, the control instructions may include information about the target object 106, such as identification of the target object 106, a location of the target object 106, a time duration during which the target object 106 is to be tracked, and/or other information. The movable object 102 identifies and initiates tracking in accordance with the instructions. In some embodiments, after tracking of the target object has been initiated, the movable object 102 may receive another set of instructions from the control unit 104 (e.g., via the user) to stop tracking the target object 106. In some circumstances, the movable object 102 may pause or stop tracking the target object 106 when the target object 106 is no longer present (or visible) in the field of view of the movable object 102 after a certain time period (e.g., 5 minutes or 10 minutes). In some embodiments, after the tracking has been paused or stopped, the movable object 102 may receive further instructions to resume tracking the target object 106.

In some embodiments, as illustrated in FIG. 1, the movable object 102 is configured to communicate with a computing device 126 (e.g., an electronic device, a computing system, and/or a server system). For example, the movable object 102 receives control instructions from the computing device 126 and/or sends data (e.g., data from the movable object sensing system 122) to the computing device 126. In some embodiments, communications from the computing device 126 to the movable object 102 are transmitted from computing device 126 to a cell tower 130 (e.g., via internet 128 and/or other cellular networks such as 4G and 5G networks) and from the cell tower 130 to the movable object 102 (e.g., via RF signals). In some embodiments, a satellite is used in lieu of or in addition to cell tower 130.

In some embodiments, the target identification and tracking system 100 includes additional control units 104 and/or computing devices 126 that are configured to communicate with the movable object 102.

FIG. 2A illustrates an exemplary movable object 102 according to some embodiments. In some embodiments, the movable object 102 includes processor(s) 116, memory 118, a communication system 120, a sensing system 122, a clock 152, and radio(s) 154, which are connected by data connections such as a control bus 112. The control bus 112 optionally includes circuitry (sometimes called a chipset) that interconnects and controls communications between system components.

In some embodiments, the movable object 102 is a UAV and includes components to enable flight and/or flight control. Although the movable object 102 is depicted as an aircraft in this example, this depiction is not intended to be limiting, and any suitable type of movable object may be used.

In some embodiments, the movable object 102 includes movement mechanisms 114 (e.g., propulsion mechanisms). Although the plural term “movement mechanisms” is used herein for convenience of reference, “movement mechanisms 114” may refer to a single movement mechanism (e.g., a single propeller) or multiple movement mechanisms (e.g., multiple rotors). The movement mechanisms 114 may include one or more movement mechanism types such as rotors, propellers, blades, engines, motors, wheels, axles, magnets, and nozzles. The movement mechanisms 114 are coupled to the movable object 102 at, e.g., the top, bottom, front, back, and/or sides. In some embodiments, the movement mechanisms 114 of a single movable object 102 may include multiple movement mechanisms each having the same type. In some embodiments, the movement mechanisms 114 of a single movable object 102 include multiple movement mechanisms with different movement mechanism types. The movement mechanisms 114 are coupled to the movable object 102 using any suitable means, such as support elements (e.g., drive shafts) or other actuating elements (e.g., one or more actuators 132). For example, the actuator 132 (e.g., movable object actuator) receives control signals from processor(s) 116 (e.g., via control bus 112) that activates the actuator to cause movement of a movement mechanism 114. For example, the processor(s) 116 include an electronic speed controller that provides control signals to the actuators 132.

In some embodiments, the movement mechanisms 114 enable the movable object 102 to take off vertically from a surface or land vertically on a surface without requiring any horizontal movement of the movable object 102 (e.g., without traveling down a runway). In some embodiments, the movement mechanisms 114 are operable to permit the movable object 102 to hover in the air at a specified position and/or orientation. In some embodiments, one or more of the movement mechanisms 114 are controllable independently of one or more of the other movement mechanisms 114. For example, when the movable object 102 is a quadcopter, each rotor of the quadcopter is controllable independently of the other rotors of the quadcopter. In some embodiments, multiple movement mechanisms 114 are configured for simultaneous movement.

In some embodiments, the movement mechanisms 114 include multiple rotors that provide lift and/or thrust to the movable object 102. The multiple rotors are actuated to provide, e.g., vertical takeoff, vertical landing, and hovering capabilities to the movable object 102. In some embodiments, one or more of the rotors spin in a clockwise direction, while one or more of the rotors spin in a counterclockwise direction. For example, the number of clockwise rotors is equal to the number of counterclockwise rotors. In some embodiments, the rotation rate of each of the rotors is independently variable, e.g., for controlling the lift and/or thrust produced by each rotor, and thereby adjusting the spatial disposition, velocity, and/or acceleration of the movable object 102 (e.g., with respect to up to three degrees of translation and/or up to three degrees of rotation).

In some embodiments, the memory 118 stores one or more instructions, programs (e.g., sets of instructions), modules, controlling systems and/or data structures, collectively referred to as “elements” herein. One or more elements described with regard to the memory 118 are optionally stored by the control unit 104, the computing device 126, and/or another device. In some embodiments, an imaging device 214 (FIG. 2C) includes memory that stores one or more parameters described with regard to the memory 118.

In some embodiments, the memory 118 stores a controlling system configuration that includes one or more system settings (e.g., as configured by a manufacturer, administrator, and/or user). For example, identifying information for the movable object 102 is stored as a system setting of the system configuration. In some embodiments, the controlling system configuration includes a configuration for the imaging device 214. The configuration for the imaging device 214 stores parameters such as position (e.g., relative to the image sensor 216), a zoom level and/or focus parameters (e.g., amount of focus, selecting autofocus or manual focus, and/or adjusting an autofocus target in an image). Imaging property parameters stored by the imaging device configuration include, e.g., image resolution, image size (e.g., image width and/or height), aspect ratio, pixel count, quality, focus distance, depth of field, exposure time, shutter speed, and/or white balance. In some embodiments, parameters stored by the imaging device configuration are updated in response to control instructions (e.g., generated by processor(s) 116 and/or received by the movable object 102 from the control unit 104 and/or the computing device 126). In some embodiments, parameters stored by the imaging device configuration are updated in response to information received from the movable object sensing system 122 and/or the imaging device 214.

In some embodiments, the carrier 108 is coupled to the movable object 102 and a payload 110 is coupled to the carrier 108. In some embodiments, the carrier 108 includes one or more mechanisms that enable the payload 110 to move relative to the movable object 102, as described further with respect to FIG. 2B. In some embodiments, the payload 110 is rigidly coupled to the movable object 102 such that the payload 110 remains substantially stationary relative to the movable object 102. For example, the carrier 108 is coupled to the payload 110 such that the payload 110 is not movable relative to the movable object 102. In some embodiments, the payload 110 is coupled to the movable object 102 without requiring the use of the carrier 108.

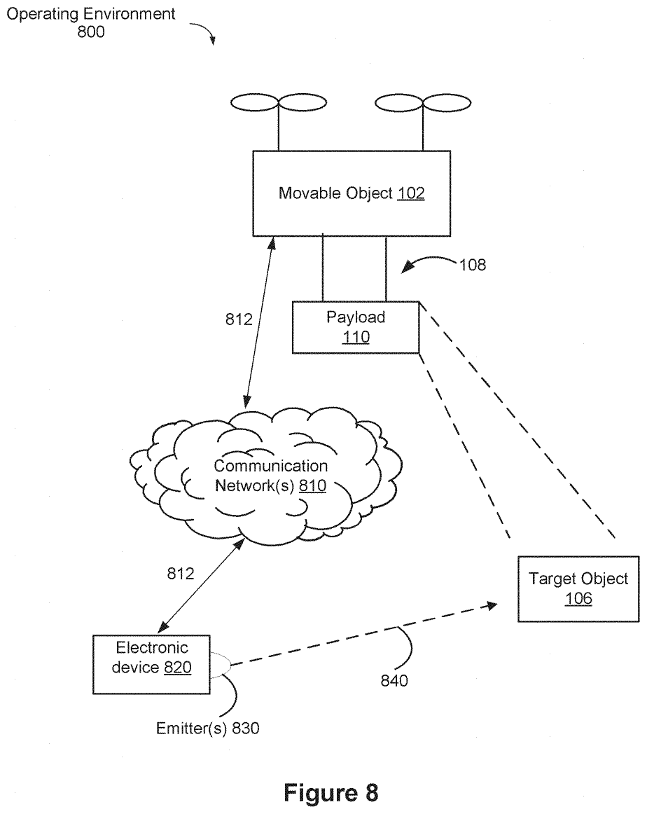

As further depicted in FIG. 2A, the movable object 102 also includes the communication system 120, which enables communication with between the movable object 102 and the control unit 104, and/or the computing device 126 (e.g., via wireless signals 124), and/or the electronic device 820 (FIG. 8). In some embodiments, the communication system 120 includes transmitters, receivers, and/or transceivers for wireless communication. In some embodiments, the communication is a one-way communication, such that data is transmitted only from the movable object 102 to the control unit 104, or vice-versa. In some embodiments, communication is a two-way communication, such that data is transmitted from the movable object 102 to the control unit 104, as well as from the control unit 104 to the movable object 102.

In some embodiments, the movable object 102 communicates with the computing device 126. In some embodiments, the movable object 102, the control unit 104, and/or the computing device 126 are connected to the Internet or other telecommunications network, e.g., such that data generated by the movable object 102, the control unit 104, and/or the computing device 126 is transmitted to a server for data storage and/or data retrieval (e.g., for display by a website). In some embodiments, data generated by the movable object 102, the control unit 104, and/or the computing device 126 is stored locally on each of the respective devices.

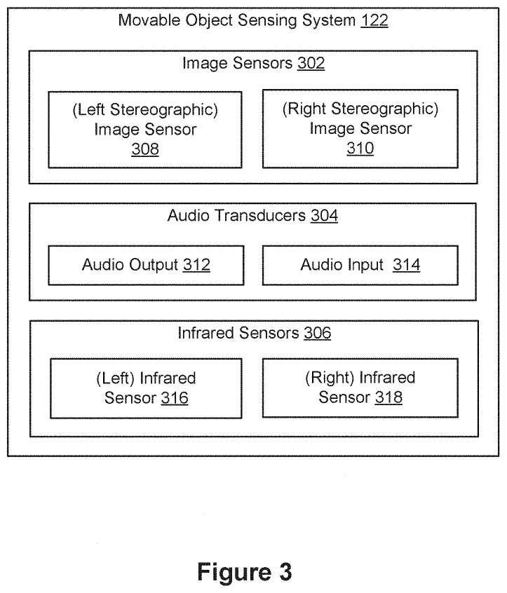

In some embodiments, the movable object 102 comprises a sensing system (e.g., the movable object sensing system 122) that includes one or more sensors, as described further with reference to FIG. 3. In some embodiments, the movable object 102 and/or the control unit 104 use sensing data generated by sensors of sensing system 122 to determine information such as a position of the movable object 102, an orientation of the movable object 102, movement characteristics of the movable object 102 (e.g., an angular velocity, an angular acceleration, a translational velocity, a translational acceleration and/or a direction of motion along one or more axes), a distance between the movable object 102 to a target object, proximity (e.g., distance) of the movable object 102 to potential obstacles, weather conditions, locations of geographical features and/or locations of manmade structures.

In some embodiments, the movable object 102 comprises radio(s) 154. The radio(s) 154 enable one or more communication networks, and allow the movable object 102 to communicate with other devices (e.g., electronic device 820, FIG. 8). In some embodiments, the radio(s) 154 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, Ultrawide Band (UWB), software defined radio (SDR) etc.) custom or standard wired protocols (e.g., Ethernet, HomePlug, etc.), and/or any other suitable communication protocol, including communication protocols not yet developed as of the filing date of this document.

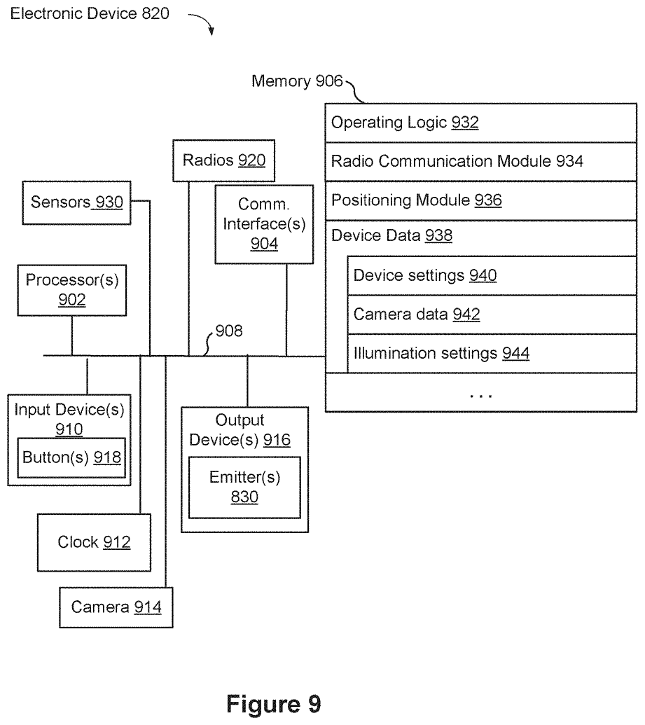

In some embodiments, the movable object 102 includes a clock 152. In some embodiments, the clock 152 synchronizes (e.g., coordinates) time with a clock 912 of an electronic device 820 (FIG. 9).

FIG. 2B illustrates an exemplary carrier 108 according to some embodiments. In some embodiments, the carrier 108 couples the payload 110 to the movable object 102.

In some embodiments, the carrier 108 includes a frame assembly having one or more frame members 202. In some embodiments, the frame member(s) 202 are coupled with the movable object 102 and the payload 110. In some embodiments, the frame member(s) 202 support the payload 110.

In some embodiments, the carrier 108 includes one or more mechanisms, such as one or more actuators 204, to cause movement of the carrier 108 and/or the payload 110. In some embodiments, the actuator 204 is, e.g., a motor, such as a hydraulic, pneumatic, electric, thermal, magnetic, and/or mechanical motor. In some embodiments, the actuator 204 causes movement of the frame member(s) 202. In some embodiments, the actuator 204 rotates the payload 110 with respect to one or more axes, such as one or more of: an X axis (“pitch axis”), a Z axis (“roll axis”), and a Y axis (“yaw axis”), relative to the movable object 102. In some embodiments, the actuator 204 translates the payload 110 along one or more axes relative to the movable object 102.

In some embodiments, the carrier 108 includes a carrier sensing system 206 for determining a state of the carrier 108 or the payload 110. The carrier sensing system 206 includes one or more of: motion sensors (e.g., accelerometers), rotation sensors (e.g., gyroscopes), potentiometers, and/or inertial sensors. In some embodiments, the carrier sensing system 206 includes one or more sensors of the movable object sensing system 122 as described below with respect to FIG. 3. Sensor data determined by the carrier sensing system 206 may include spatial disposition (e.g., position, orientation, or attitude), movement information such as velocity (e.g., linear or angular velocity) and/or acceleration (e.g., linear or angular acceleration) of the carrier 108 and/or the payload 110. In some embodiments, the sensing data as well as state information calculated from the sensing data are used as feedback data to control the movement of one or more components (e.g., the frame member 202(s), the actuator 204, and/or the damping element 208) of the carrier 108. In some embodiments, the carrier sensing system 206 is coupled to the frame member(s) 202, the actuator 204, the damping element 208, and/or the payload 110. In some instances, a sensor in the carrier sensing system 206 (e.g., a potentiometer) may measure movement of the actuator 204 (e.g., the relative positions of a motor rotor and a motor stator) and generate a position signal representative of the movement of the actuator 204 (e.g., a position signal representative of relative positions of the motor rotor and the motor stator). In some embodiments, data generated by the sensors is received by processor(s) 116 and/or memory 118 of the movable object 102.

In some embodiments, the coupling between the carrier 108 and the movable object 102 includes one or more damping elements 208. The damping element(s) 208 are configured to reduce or eliminate movement of the load (e.g., the payload 110 and/or the carrier 108) caused by movement of the movable object 102. The damping element(s) 208 may include active damping elements, passive damping elements, and/or hybrid damping elements having both active and passive damping characteristics. The motion damped by the damping element(s) 208 may include vibrations, oscillations, shaking, and/or impacts. Such motions may originate from motions of the movable object 102, which are transmitted to the payload 110. For example, the motion may include vibrations caused by the operation of a propulsion system and/or other components of the movable object 102.

In some embodiments, the damping element(s) 208 provide motion damping by isolating the payload 110 from the source of unwanted motion, by dissipating or reducing the amount of motion transmitted to the payload 110 (e.g., vibration isolation). In some embodiments, the damping element 208(s) reduce a magnitude (e.g., an amplitude) of the motion that would otherwise be experienced by the payload 110. In some embodiments, the motion damping applied by the damping element(s) 208 is used to stabilize the payload 110, thereby improving the quality of video and/or images captured by the payload 110 (e.g., using the imaging device 214, FIG. 2C). In some embodiments, the improved video and/or image quality reduces the computational complexity of processing steps required to generate an edited video based on the captured video, or to generate a panoramic image based on the captured images.

In some embodiments, the damping element(s) 208 may be manufactured using any suitable material or combination of materials, including solid, liquid, or gaseous materials. The materials used for the damping element(s) 208 may be compressible and/or deformable. In one example, the damping element(s) 208 may be made of sponge, foam, rubber, gel, and the like. In another example, the damping element(s) 208 may include rubber balls that are substantially spherical in shape. In other instances, the damping element(s) 208 may be substantially spherical, rectangular, and/or cylindrical in shape. In some embodiments, the damping element(s) 208 may include piezoelectric materials or shape memory materials. In some embodiments, the damping element(s) 208 may include one or more mechanical elements, such as springs, pistons, hydraulics, pneumatics, dashpots, shock absorbers, and/or isolators. In some embodiments, properties of the damping element(s) 208 are selected so as to provide a predetermined amount of motion damping. In some instances, the damping element(s) 208 have viscoelastic properties. The properties of damping element(s) 208 may be isotropic or anisotropic. In some embodiments, the damping element(s) 208 provide motion damping equally along all directions of motion. In some embodiments, the damping element(s) 208 provide motion damping only along a subset of the directions of motion (e.g., along a single direction of motion). For example, the damping element(s) 208 may provide damping primarily along the Y (yaw) axis. In this manner, the illustrated damping element(s) 208 reduce vertical motions.

In some embodiments, the carrier 108 further includes a controller 210. The controller 210 may include one or more controllers and/or processors. In some embodiments, the controller 210 receives instructions from the processor(s) 116 of the movable object 102. For example, the controller 210 may be connected to the processor(s) 116 via the control bus 112. In some embodiments, the controller 210 may control movement of the actuator 204, adjust one or more parameters of the carrier sensing system 206, receive data from carrier sensing system 206, and/or transmit data to the processor(s) 116.

FIG. 2C illustrates an exemplary payload 110 according to some embodiments. In some embodiments, the payload 110 includes a payload sensing system 212 and a controller 218. The payload sensing system 212 may include an imaging device 214 (e.g., a camera) having an image sensor 216 with a field of view. In some embodiments, the payload sensing system 212 includes one or more sensors of the movable object sensing system 122, as described below with respect to FIG. 3.

The payload sensing system 212 generates static sensing data (e.g., a single image captured in response to a received instruction) and/or dynamic sensing data (e.g., a series of images captured at a periodic rate, such as a video).

The image sensor 216 is, e.g., a sensor that detects light, such as visible light, infrared light, and/or ultraviolet light. In some embodiments, the image sensor 216 includes, e.g., semiconductor charge-coupled device (CCD), active pixel sensors using complementary metal-oxide-semiconductor (CMOS) or N-type metal-oxide-semiconductor (NMOS, Live MOS) technologies, or any other types of sensors. The image sensor 216 and/or imaging device 214 captures images or image streams (e.g., videos). Adjustable parameters of imaging device 214 include, e.g., width, height, aspect ratio, pixel count, resolution, quality, imaging mode, focus distance, depth of field, exposure time, shutter speed and/or lens configuration. In some embodiments, the imaging device 214 may configured to capture videos and/or images at different resolutions (e.g., low, medium, high, or ultra-high resolutions, and/or high-definition or ultra-high-definition videos such as 720p, 1080i, 1080p, 1440p, 2000p, 2160p, 2540p, 4000p, and 4320p).

In some embodiments, the payload 110 includes the controller 218. The controller 218 may include one or more controllers and/or processors. In some embodiments, the controller 218 receives instructions from the processor(s) 116 of the movable object 102. For example, the controller 218 is connected to the processor(s) 116 via the control bus 112. In some embodiments, the controller 218 may adjust one or more parameters of one or more sensors of the payload sensing system 212, receive data from one or more sensors of payload sensing system 212, and/or transmit data, such as image data from the image sensor 216, to the processor(s) 116, the memory 118, and/or the control unit 104.

In some embodiments, data generated by one or more sensors of the payload sensor system 212 is stored, e.g., by the memory 118. In some embodiments, data generated by the payload sensor system 212 are transmitted to the control unit 104 (e.g., via communication system 120). For example, video is streamed from the payload 110 (e.g., the imaging device 214) to the control unit 104. In this manner, the control unit 104 displays, e.g., real-time (or slightly delayed) video received from the imaging device 214.

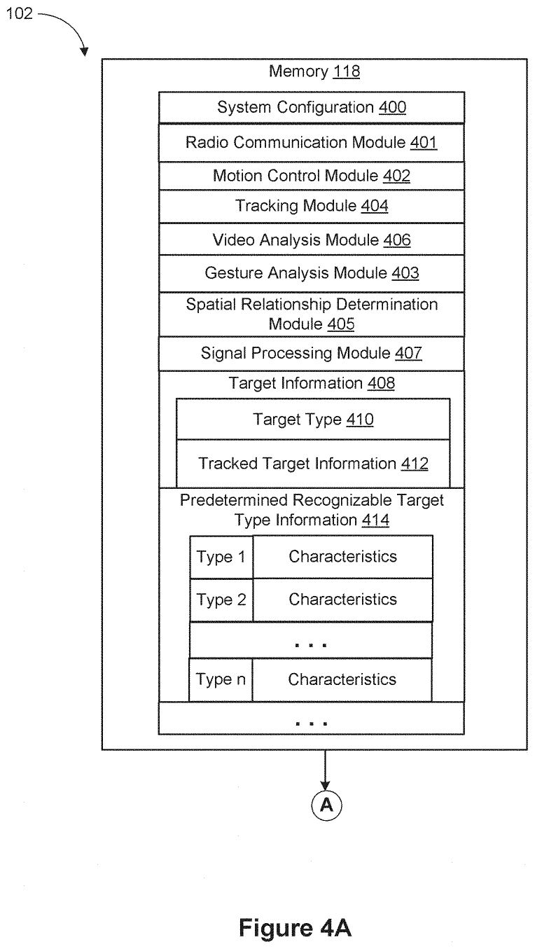

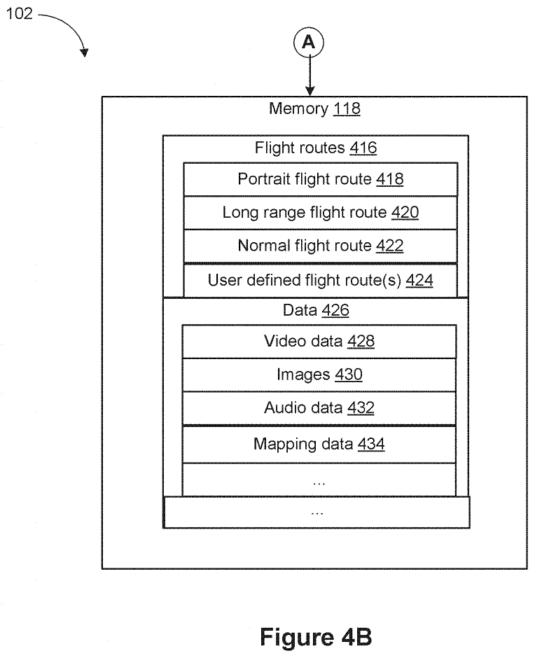

In some embodiments, an adjustment of the orientation, position, altitude, and/or one or more movement characteristics of the movable object 102, the carrier 108, and/or the payload 110 is generated (e.g., by the processor(s) 116) based at least in part on configurations (e.g., preset and/or user configured in system configuration 400, FIG. 4) of the movable object 102, the carrier 108, and/or the payload 110. For example, an adjustment that involves a rotation with respect to two axes (e.g., yaw and pitch) is achieved solely by corresponding rotation of movable object around the two axes if the payload 110 including imaging device 214 is rigidly coupled to the movable object 102 (and hence not movable relative to movable object 102) and/or the payload 110 is coupled to the movable object 102 via a carrier 108 that does not permit relative movement between the imaging device 214 and the movable object 102. The same two-axis adjustment may be achieved by, e.g., combining adjustments of both the movable object 102 and the carrier 108 if the carrier 108 permits the imaging device 214 to rotate around at least one axis relative to the movable object 102. In this case, the carrier 108 can be controlled to implement the rotation around one or two of the two axes required for the adjustment and the movable object 120 can be controlled to implement the rotation around one or two of the two axes. In some embodiments, the carrier 108 may include a one-axis gimbal that allows the imaging device 214 to rotate around one of the two axes required for adjustment while the rotation around the remaining axis is achieved by the movable object 102. In some embodiments, the same two-axis adjustment is achieved by the carrier 108 alone when the carrier 108 permits the imaging device 214 to rotate around two or more axes relative to the movable object 102. In some embodiments, the carrier 108 may include a two-axis or three-axis gimbal that enables the imaging device 214 to rotate around two or all three axes.

FIG. 3 illustrates an exemplary sensing system 122 of a movable object 102 according to some embodiments. In some embodiments, one or more sensors of the movable object sensing system 122 are mounted to an exterior, or located within, or otherwise coupled to the movable object 102. In some embodiments, one or more sensors of movable object sensing system are components of carrier sensing system 206 and/or payload sensing system 212. Where sensing operations are described as being performed by the movable object sensing system 122 herein, it will be recognized that such operations are optionally performed by the carrier sensing system 206 and/or the payload sensing system 212.

In some embodiments, the movable object sensing system 122 generates static sensing data (e.g., a single image captured in response to a received instruction) and/or dynamic sensing data (e.g., a series of images captured at a periodic rate, such as a video).

In some embodiments, the movable object sensing system 122 includes one or more image sensors 302, such as image sensor 308 (e.g., a left stereographic image sensor) and/or image sensor 310 (e.g., a right stereographic image sensor). The image sensors 302 capture, e.g., images, image streams (e.g., videos), stereographic images, and/or stereographic image streams (e.g., stereographic videos). The image sensors 302 detect light, such as visible light, infrared light, and/or ultraviolet light. In some embodiments, the movable object sensing system 122 includes one or more optical devices (e.g., lenses) to focus or otherwise alter the light onto the one or more image sensors 302. In some embodiments, the image sensors 302 include, e.g., semiconductor charge-coupled devices (CCD), active pixel sensors using complementary metal-oxide-semiconductor (CMOS) or N-type metal-oxide-semiconductor (NMOS, Live MOS) technologies, or any other types of sensors.

In some embodiments, the movable object sensing system 122 includes one or more audio transducers 304. The audio transducers 304 may include an audio output transducer 312 (e.g., a speaker), and an audio input transducer 314 (e.g. a microphone, such as a parabolic microphone). In some embodiments, the audio output transducer 312 and the audio input transducer 314 are used as components of a sonar system for tracking a target object (e.g., detecting location information of a target object).

In some embodiments, the movable object sensing system 122 includes one or more infrared sensors 306. In some embodiments, a distance measurement system includes a pair of infrared sensors e.g., infrared sensor 316 (such as a left infrared sensor) and infrared sensor 318 (such as a right infrared sensor) or another sensor or sensor pair. The distance measurement system is used for measuring a distance between the movable object 102 and the target object 106.

In some embodiments, the movable object sensing system 122 may include other sensors for sensing a distance between the movable object 102 and the target object 106, such as a Radio Detection and Ranging (RADAR) sensor, a Light Detection and Ranging (LiDAR) sensor, or any other distance sensor.

In some embodiments, a system to produce a depth map includes one or more sensors or sensor pairs of movable object sensing system 122 (such as a left stereographic image sensor 308 and a right stereographic image sensor 310; an audio output transducer 312 and an audio input transducer 314; and/or a left infrared sensor 316 and a right infrared sensor 318. In some embodiments, a pair of sensors in a stereo data system (e.g., a stereographic imaging system) simultaneously captures data from different positions. In some embodiments, a depth map is generated by a stereo data system using the simultaneously captured data. In some embodiments, a depth map is used for positioning and/or detection operations, such as detecting a target object 106, and/or detecting current location information of a target object 106.

In some embodiments, the movable object sensing system 122 includes one or more global positioning system (GPS) sensors, motion sensors (e.g., accelerometers), rotation sensors (e.g., gyroscopes), inertial sensors, proximity sensors (e.g., infrared sensors) and/or weather sensors (e.g., pressure sensor, temperature sensor, moisture sensor, and/or wind sensor).

In some embodiments, sensing data generated by one or more sensors of the movable object sensing system 122 and/or information determined using sensing data from one or more sensors of the movable object sensing system 122 are transmitted to the control unit 104 (e.g., via the communication system 120). In some embodiments, data generated one or more sensors of the movable object sensing system 122 and/or information determined using sensing data from one or more sensors of the movable object sensing system 122 is stored by the memory 118.

FIGS. 4A and 4B illustrate a block diagram of an exemplary memory 118 of a movable object 102 according to some embodiments. In some embodiments, one or more elements illustrated in FIGS. 4A and/or 4B may be located in the control unit 104, the computing device 126, and/or another device.

In some embodiments, the memory 118 stores a system configuration 400. The system configuration 400 includes one or more system settings (e.g., as configured by a manufacturer, administrator, and/or user of the movable object 102). For example, a constraint on one or more of orientation, position, attitude, and/or one or more movement characteristics of the movable object 102, the carrier 108, and/or the payload 110 is stored as a system setting of the system configuration 400.

In some embodiments, the memory 118 stores a radio communication module 401. The radio communication module 401 connects to and communicates with other network devices (e.g., a local network, such as a router that provides Internet connectivity, networked storage devices, network routing devices, electronic device 820 etc.) that are coupled to one or more communication networks (e.g., communication network(s) 810, FIG. 8) via the communication system 120 (wired or wireless).

In some embodiments, the memory 118 stores a motion control module 402. The motion control module 402 stores control instructions that are received from the control module 104 and/or the computing device 126. The control instructions are used for controlling operation of the movement mechanisms 114, the carrier 108, and/or the payload 110.

In some embodiments, memory 118 stores a tracking module 404. In some embodiments, the tracking module 404 generates tracking information for a target object 106 that is being tracked by the movable object 102. In some embodiments, the tracking information is generated based on images captured by the imaging device 214 and/or based on output from an video analysis module 406 (e.g., after pre-processing and/or processing operations have been performed on one or more images) and/or based on input of a user. Alternatively or in combination, the tracking information may be generated based on analysis of gestures of a human target, which are captured by the imaging device 214 and/or analyzed by a gesture analysis module 403. The tracking information generated by the tracking module 404 may include a location, a size, and/or other characteristics of the target object 106 within one or more images. In some embodiments, the tracking information generated by the tracking module 404 is transmitted to the control unit 104 and/or the computing device 126 (e.g., augmenting or otherwise combined with images and/or output from the video analysis module 406). For example, the tracking information may be transmitted to the control unit 104 in response to a request from the control unit 104 and/or on a periodic basis (e.g., every 2 seconds, 5 seconds, 10 seconds, or 30 seconds).

In some embodiments, the memory 118 includes a video analysis module 406. The video analysis module 406 performs processing operations on videos and images, such as videos and images captured by the imaging device 214. In some embodiments, the video analysis module 406 performs pre-processing on raw video and/or image data, such as re-sampling to assure the correctness of the image coordinate system, noise reduction, contrast enhancement, and/or scale space representation. In some embodiments, the processing operations performed on video and image data (including data of videos and/or images that has been pre-processed) include feature extraction, image segmentation, data verification, image recognition, image registration, and/or image matching. In some embodiments, the output from the video analysis module 406 (e.g., after the pre-processing and/or processing operations have been performed) is transmitted to the control unit 104 and/or the computing device 126. In some embodiments, feature extraction is performed by the control unit 104, the processor(s) 116 of the movable object 102, and/or the computing device 126. In some embodiments, the video analysis module 406 may use neural networks to perform image recognition and/or classify object(s) that are included in the videos and/or images. For example, the video analysis module 406 may extract frames that include the target object 106, analyze features of the target object 106, and compare the features with characteristics of one or more predetermined recognizable target object types, thereby enabling the target object 106 to be recognized at a certain confidence level.

In some embodiments, the memory 118 includes a gesture analysis module 403. The gesture analysis module 403 processes gestures of one or more human targets. In some embodiments, the gestures may be captured by the imaging device 214. In some embodiments, after processing the gestures, the gesture analysis results may be fed into the tracking module 404 and/or the motion control module 402 to generate, respectively, tracking information and/or control instructions that are used for controlling operations of the movement mechanisms 114, the carrier 108, and/or the payload 110 of the movable object 102.

In some embodiments, a calibration process may be performed before using gestures of a human target to control the movable object 102. For example, during the calibration process, the gesture analysis module 403 may capture certain features of human gestures associated with a certain control command and stores the gesture features in the memory 118. When a human gesture is received, the gesture analysis module 403 may extract features of the human gesture and compare these features with the stored features to determine whether the certain command may be performed by the user. In some embodiments, the correlations between gestures and control commands associated with a certain human target may or may not be different from such correlations associated with another human target.

In some embodiments, the memory 118 includes a spatial relationship determination module 405. The spatial relationship determination module 405 calculates one or more spatial relationships between the target object 106 and the movable object 102, such as a horizontal distance between the target object 106 and the movable object 102, and/or a pitch angle between the target object 106 and the movable object 102.

In some embodiments, the memory 118 includes a signal processing module 407. The signal processing module 407 processes signals (e.g., wireless signals) that are received by the movable object 102 (e.g., from an electronic device 802, FIG. 8). In some embodiments, the movable object 102 uses the signals to determine position (e.g., positional coordinates) of the target object 106. In some embodiments, the signals may include direction(s) of illumination, pattern(s) of illumination, wavelength(s) (e.g., color) of illumination, and/or temporal frequencies of illumination, and/or times of illumination, and/or intensities of illumination. In some embodiments, the signals may include a position of the electronic device 820.

In some embodiments, the memory 118 stores target information 408. In some embodiments, the target information 408 is received by the movable object 102 (e.g., via communication system 120) from the control unit 104, the computing device 126, the target object 106, and/or another movable object.

In some embodiments, the target information 408 includes a time value (e.g., a time duration) and/or an expiration time indicating a period of time during which the target object 106 is to be tracked. In some embodiments, the target information 408 includes a flag (e.g., a label) indicating whether a target information entry includes specific tracked target information 412 and/or target type information 410.

In some embodiments, the target information 408 includes target type information 410 such as color, texture, pattern, size, shape, and/or dimension. In some embodiments, the target type information 410 includes, but is not limited to, a predetermined recognizable object type and a general object type as identified by the video analysis module 406. In some embodiments, the target type information 410 includes features or characteristics for each type of target and is preset and stored in the memory 118. In some embodiments, the target type information 410 is provided to a user input device (e.g., the control unit 104) via user input. In some embodiments, the user may select a pre-existing target pattern or type (e.g., an object or a round object with a radius greater or less than a certain value).

In some embodiments, the target information 408 includes tracked target information 412 for a specific target object 106 being tracked. The target information 408 may be identified by the video analysis module 406 by analyzing the target in a captured image. The tracked target information 412 includes, e.g., an image of the target object 106, an initial position (e.g., location coordinates, such as pixel coordinates within an image) of the target object 106, and/or a size of the target object 106 within one or more images (e.g., images captured by the imaging device 214). A size of the target object 106 is stored, e.g., as a length (e.g., mm or other length unit), an area (e.g., mm² or other area unit), a number of pixels in a line (e.g., indicating a length, width, and/or diameter), a ratio of a length of a representation of the target in an image relative to a total image length (e.g., a percentage), a ratio of an area of a representation of the target in an image relative to a total image area (e.g., a percentage), a number of pixels indicating an area of target object 106, and/or a corresponding spatial relationship (e.g., a vertical distance and/or a horizontal distance) between the target object 106 and the movable object 102 (e.g., an area of the target object 106 changes based on a distance of the target object 106 from the movable object 102).

In some embodiments, one or more features (e.g., characteristics) of the target object 106 are determined from an image of the target object 106 (e.g., using image analysis techniques on images captured by the imaging device 112). For example, one or more features of the target object 106 are determined from an orientation and/or part or all of identified boundaries of the target object 106. In some embodiments, the tracked target information 412 includes pixel coordinates and/or a number of pixel counts to indicate, e.g., a size parameter, position, and/or shape of the target object 106. In some embodiments, one or more features of the tracked target information 412 are to be maintained as the movable object 102 tracks the target object 106 (e.g., the tracked target information 412 are to be maintained as images of the target object 106 are captured by the imaging device 214). In some embodiments, the tracked target information 412 is used to adjust the movable object 102, the carrier 108, and/or the imaging device 214, such that specific features of the target object 106 are substantially maintained. In some embodiments, the tracked target information 412 is determined based on one or more of the target types 410.

In some embodiments, the memory 118 also includes predetermined recognizable target type information 414. The predetermined recognizable target type information 414 specifies one or more characteristics of certain predetermined recognizable target types (e.g., target type 1, target type 2, . . . , target type n). Each predetermined recognizable target type may include one or more characteristics such as a size parameter (e.g., area, diameter, height, length and/or width), position (e.g., relative to an image center and/or image boundary), movement (e.g., speed, acceleration, altitude) and/or shape. For example, target type 1 may be a human target. One or more characteristics associated with a human target may include a height in a range from about 1.4 meters to about 2 meters, a pattern comprising a head, shoulders, the head-shoulder ratio, a torso, the head-torso ratio, joints and/or limbs, and/or a moving speed having a range from about 2 kilometers/hour to about 25 kilometers/hour. In another example, target type 2 may be a car target. One or more characteristics associated with a car target may include a height in a range from about 1.4 meters to about 4.5 meters, a length having a range from about 3 meters to about 10 meters, a moving speed of 5 kilometers/hour to about 140 kilometers/hour, and/or a pattern of a sedan, a SUV, a truck, or a bus. In yet another example, target type 3 may be a ship target. Other types of predetermined recognizable target object may also include: an airplane target, an animal target, other moving targets, and stationary (e.g., non-moving) targets such as a building and a statue. Each predetermined target type may further include one or more subtypes, each of the subtypes having more specific characteristics thereby providing more accurate target classification results.

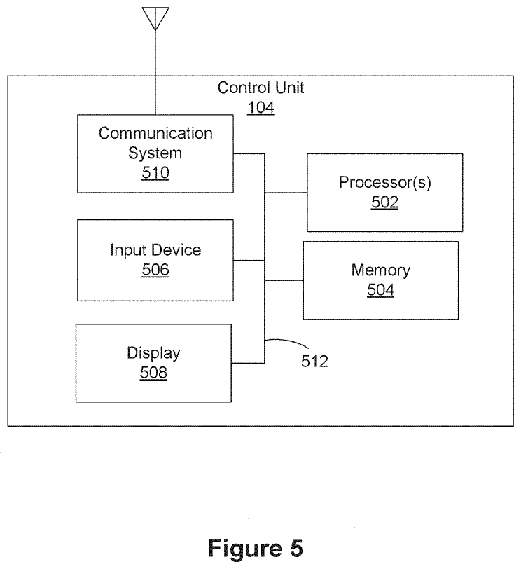

In some embodiments, the target information 408 (including, e.g., the target type information 410 and the tracked target information 412), and/or predetermined recognizable target information 414 is generated based on user input, such as a user input received at user input device 506 (FIG. 5) of the control unit 104. Additionally or alternatively, the target information 408 may be generated based on data from sources other than the control unit 104. For example, the target type information 410 may be based on previously stored images of the target object 106 (e.g., images captured by the imaging device 214 and stored by the memory 118), other data stored by the memory 118, and/or data from data stores that are remote from the control unit 104 and/or the movable object 102. In some embodiments, the target type information 408 is generated using a computer-generated image of the target object 106.

In some embodiments, the target information 408 is used by the movable object 102 (e.g., the tracking module 404) to track the target object 106. In some embodiments, the target information 408 is used by a video analysis module 406 to identify and/or classify the target object 106. In some cases, target identification involves image recognition and/or matching algorithms based on, e.g., CAD-like object models, appearance-based methods, feature-based methods, and/or genetic algorithms. In some embodiments, target identification includes comparing two or more images to determine, extract, and/or match features contained therein.

In some embodiments, the memory 118 also includes flight routes 416 (e.g., predefined flight routes) of the movable object 102, such as a portrait flight route 418 (e.g., when the target object 106 is a person), a long range flight route 420, and a normal flight route 422. Each of the flight routes 416 includes one or more flight paths, each of the one or more paths having a corresponding trajectory mode. In some embodiments, the movable object 102 automatically selects one of the predefined flight routes according to a target type of the target object 106 and executes an autonomous flight according to the predefined flight route. In some embodiments, after automatically selecting a flight route 416 for the movable object 102, the movable object 102 further performs an automatic customization of the flight route taking into consideration factors such as a distance between the movable object 102 and the target object 106, presence of potential obstacle(s) and/or other structures (e.g., buildings and trees), or weather conditions. In some embodiments, customization of the flight route includes modifying a rate of ascent of the movable object 102, an initial velocity of the movable object 102, and/or an acceleration of the movable object 102. In some embodiments, the customization is provided in part by a user. For example, depending on the target type and the distance, the movable object 102 may cause the computing device 126 to display a library of trajectories that can be selected by the user. The movable object 102 then automatically generates the paths of the flight route based on the user selections.

In some embodiments, the flight routes 416 also include user defined flight route(s) 424, which are routes that are defined and customized by the user. For example, in some embodiments, the user may define a flight route using the control unit 104 (e.g., by identifying two or more points of interests on a map that is displayed on the control unit 104). The control unit 104 may transmit to the movable object 102 a user defined flight route 424 that includes the identified points of interest and/or positional coordinates of the identified points of interest.

In some embodiments, the memory stores data 426 that are captured by the image sensor 216 during an autonomous flight, including video data 428 and image(s) 430. In some embodiments, the data 426 also includes audio data 432 that are captured by a microphone of the movable object 102 (e.g., the audio input transducer 314). In some embodiments, the data 426 is simultaneously stored on the moving object 102 as it is being captured. In some embodiments, the memory 118 further stores with the data 426 metadata information. For example, the video data 428 may include tag information (e.g., metadata) that identifies the flight path and trajectory mode corresponding to a respective segment of the video data 428.

In some embodiments, the data 426 further includes mapping data 434. The mapping data comprises mapping relationships between flight routes 416 and illumination characteristics (e.g., temporal frequencies, wavelengths, illumination types, and/or colors) from emitter(s) 830 of an electronic device 820.

The above identified modules or programs (i.e., sets of instructions) need not be implemented as separate software programs, procedures or modules, and thus various subsets of these modules may be combined or otherwise re-arranged in various embodiments. In some embodiments, the memory 118 may store a subset of the modules and data structures identified above. Furthermore, the memory 118 may store additional modules and data structures not described above. In some embodiments, the programs, modules, and data structures stored in the memory 118, or a non-transitory computer readable storage medium of the memory 118, provide instructions for implementing respective operations in the methods described below. In some embodiments, some or all of these modules may be implemented with specialized hardware circuits that subsume part or all of the module functionality. One or more of the above identified elements may be executed by the one or more processors 116 of the movable object 102. In some embodiments, one or more of the above identified elements is executed by one or more processors of a device remote from the movable object 102, such as the control unit 104 and/or the computing device 126.

FIG. 5 illustrates an exemplary control unit 104 of the target identification and tracking system 100, in accordance with some embodiments. In some embodiments, the control unit 104 communicates with the movable object 102 via the communication system 120, e.g., to provide control instructions to the movable object 102. Although the control unit 104 is typically a portable (e.g., handheld) device, the control unit 104 need not be portable. In some embodiments, the control unit 104 is a dedicated control device (e.g., dedicated to operation of movable object 102), a laptop computer, a desktop computer, a tablet computer, a gaming system, a wearable device (e.g., watches, glasses, gloves, and/or helmet), a microphone, and/or a combination thereof.

The control unit 104 typically includes one or more processor(s) 502, a communication system 510 (e.g., including one or more network or other communications interfaces), memory 504, one or more input/output (I/O) interfaces (e.g., an input device 506 and/or a display 506), and one or more communication buses 512 for interconnecting these components.

In some embodiments, the input device 506 and/or the display 508 comprises a touchscreen display. The touchscreen display optionally uses LCD (liquid crystal display) technology, LPD (light emitting polymer display) technology, or LED (light emitting diode) technology, although other display technologies are used in other embodiments. The touchscreen display and the processor(s) 502 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the touchscreen display.

In some embodiments, the input device 506 includes one or more: joysticks, switches, knobs, slide switches, buttons, dials, keypads, keyboards, mice, audio transducers (e.g., microphones for voice control systems), motion sensors, and/or gesture controls. In some embodiments, an I/O interface of the control unit 104 includes sensors (e.g., GPS sensors, and/or accelerometers), audio output transducers (e.g., speakers), and/or one or more tactile output generators for generating tactile outputs.

In some embodiments, the input device 506 receives user input to control aspects of the movable object 102, the carrier 108, the payload 110, or a component thereof. Such aspects include, e.g., attitude (e.g., aviation), position, orientation, velocity, acceleration, navigation, and/or tracking. For example, the input device 506 is manually set to one or more positions by a user. Each of the positions may correspond to a predetermined input for controlling the movable object 102. In some embodiments, the input device 506 is manipulated by a user to input control instructions for controlling the navigation of the movable object 102. In some embodiments, the input device 506 is used to input a flight mode for the movable object 102, such as auto pilot or navigation according to a predetermined navigation path.

In some embodiments, the input device 506 is used to input a target tracking mode for the movable object 102, such as a manual tracking mode or an automatic tracking mode. In some embodiments, the user controls the movable object 102, e.g., the position, attitude, and/or orientation of the movable object 102, by changing a position of the control unit 104 (e.g., by tilting or otherwise moving the control unit 104). For example, a change in a position of the control unit 104 may detected by one or more inertial sensors and output of the one or more inertial sensors may be used to generate command data. In some embodiments, the input device 506 is used to adjust an operational parameter of the payload, such as a parameter of the payload sensing system 212 (e.g., to adjust a zoom parameter of the imaging device 214) and/or an attitude of the payload 110 relative to the carrier 108 and/or the movable object 102.

In some embodiments, the input device 506 is used to indicate information about the target object 106, e.g., to select a target object 106 to track and/or to indicate the target type information 412. In some embodiments, the input device 506 is used for interaction with augmented image data. For example, an image displayed by the display 508 includes representations of one or more target objects 106. In some embodiments, representations of the one or more target objects 106 are augmented to indicate identified objects for potential tracking and/or a target object 106 that is currently being tracked. Augmentation includes, for example, a graphical tracking indicator (e.g., a box) adjacent to or surrounding a respective target object 106. In some embodiments, the input device 506 is used to select a target object 106 to track or to change the target object being tracked. In some embodiments, a target object 106 is selected when an area corresponding to a representation of the target object 106 is selected by e.g., a finger, stylus, mouse, joystick, or other component of the input device 506. In some embodiments, the specific target information 412 is generated when a user selects a target object 106 to track.

The control unit 104 may also be configured to allow a user to enter target information using any suitable method. In some embodiments, the input device 506 receives a selection of a target object 106 from one or more images (e.g., video or snapshot) displayed by the display 508. For example, the input device 506 receives input including a selection performed by a gesture around the target object 106 and/or a contact at a location corresponding to the target object 106 in an image. In some embodiments, computer vision or other techniques are used to determine a boundary of the target object 106. In some embodiments, input received at the input device 506 defines a boundary of the target object 106. In some embodiments, multiple targets are simultaneously selected. In some embodiments, a selected target is displayed with a selection indicator (e.g., a bounding box) to indicate that the target is selected for tracking. In some other embodiments, the input device 506 receives input indicating information such as color, texture, shape, dimension, and/or other characteristics associated with a target object 106. For example, the input device 506 includes a keyboard to receive typed input indicating the target information 408.

In some embodiments, the control unit 104 provides an interface that enables a user to select (e.g., using the input device 506) between a manual tracking mode and an automatic tracking mode. When the manual tracking mode is selected, the interface enables the user to select a target object 106 to track. For example, a user is enabled to manually select a representation of a target object 106 from an image displayed by the display 508 of the control unit 104. Specific target information 412 associated with the selected target object 106 is transmitted to the movable object 102, e.g., as initial expected target information.

In some embodiments, when the automatic tracking mode is selected, the user does not provide input selecting a target object 106 to track. In some embodiments, the input device 506 receives target type information 410 from a user input. In some embodiments, the movable object 102 uses the target type information 410, e.g., to automatically identify the target object 106 to be tracked and/or to track the identified target object 106.

Typically, manual tracking requires more user control of the tracking of the target and less automated processing or computation (e.g., image or target recognition) by the processor(s) 116 of the movable object 102, while automatic tracking requires less user control of the tracking process but more computation performed by the processor(s) 116 of the movable object 102 (e.g., by the video analysis module 406). In some embodiments, allocation of control over the tracking process between the user and the onboard processing system is adjusted, e.g., depending on factors such as the surroundings of movable object 102, motion of the movable object 102, altitude of the movable object 102, the system configuration 400 (e.g., user preferences), and/or available computing resources (e.g., CPU or memory) of the movable object 102, the control unit 104, and/or the computing device 126. For example, relatively more control is allocated to the user when movable object is navigating in a relatively complex environment (e.g., with numerous buildings or obstacles or indoor) than when movable object is navigating in a relatively simple environment (e.g., wide open space or outdoor). As another example, more control is allocated to the user when the movable object 102 is at a lower altitude than when the movable object 102 is at a higher altitude. As a further example, more control is allocated to the movable object 102 if the movable object 102 is equipped with a high-speed processor adapted to perform complex computations relatively quickly. In some embodiments, the allocation of control over the tracking process between the user and the movable object 102 is dynamically adjusted based on one or more of the factors described herein.

In some embodiments, the control unit 104 includes an electronic device (e.g., a portable electronic device) and an input device 506 that is a peripheral device that is communicatively coupled (e.g., via a wireless and/or wired connection) and/or mechanically coupled to the electronic device. For example, the control unit 104 includes a portable electronic device (e.g., a cellphone or a smart phone) and a remote control device (e.g., a standard remote control with a joystick) coupled to the portable electronic device. In this example, an application executed by the cellphone generates control instructions based on input received at the remote control device.

In some embodiments, the display device 508 displays information about the movable object 102, the carrier 108, and/or the payload 110, such as position, attitude, orientation, movement characteristics of the movable object 102, and/or distance between the movable object 102 and another object (e.g., the target object 106 and/or an obstacle). In some embodiments, information displayed by the display device 508 includes images captured by the imaging device 214, tracking data (e.g., a graphical tracking indicator applied to a representation of the target object 106, such as a box or other shape around the target object 106 shown to indicate that target object 106 is currently being tracked), and/or indications of control data transmitted to the movable object 102. In some embodiments, the images including the representation of the target object 106 and the graphical tracking indicator are displayed in substantially real-time as the image data and tracking information are received from the movable object 102 and/or as the image data is acquired.

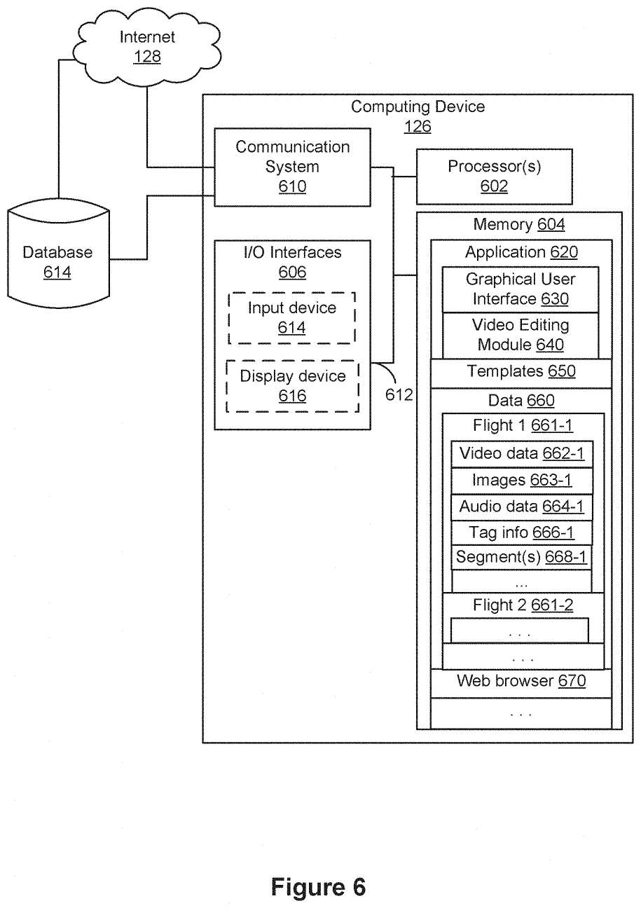

The communication system 510 enables communication with the communication system 120 of the movable object 102, the communication system 610 (FIG. 6) of the computing device 126, and/or a base station (e.g., computing device 126) via a wired or wireless communication connection. In some embodiments, the communication system 510 transmits control instructions (e.g., navigation control instructions, target information, and/or tracking instructions). In some embodiments, the communication system 510 receives data (e.g., tracking data from the payload imaging device 214, and/or data from movable object sensing system 122). In some embodiments, the control unit 104 receives tracking data (e.g., via the wireless communications 124) from the movable object 102. Tracking data is used by the control unit 104 to, e.g., display the target object 106 as the target is being tracked. In some embodiments, data received by the control unit 104 includes raw data (e.g., raw sensing data as acquired by one or more sensors) and/or processed data (e.g., raw data as processed by, e.g., the tracking module 404).

In some embodiments, the memory 504 stores instructions for generating control instructions automatically and/or based on input received via the input device 506. The control instructions may include control instructions for operating the movement mechanisms 114 of the movable object 102 (e.g., to adjust the position, attitude, orientation, and/or movement characteristics of the movable object 102, such as by providing control instructions to the actuators 132). In some embodiments, the control instructions adjust movement of the movable object 102 with up to six degrees of freedom. In some embodiments, the control instructions are generated to initialize and/or maintain tracking of the target object 106. In some embodiments, the control instructions include instructions for adjusting the carrier 108 (e.g., instructions for adjusting the damping element 208, the actuator 204, and/or one or more sensors of the carrier sensing system 206). In some embodiments, the control instructions include instructions for adjusting the payload 110 (e.g., instructions for adjusting one or more sensors of the payload sensing system 212). In some embodiments, the control instructions include control instructions for adjusting the operations of one or more sensors of movable the object sensing system 122.

In some embodiments, the memory 504 also stores instructions for performing image recognition, target classification, spatial relationship determination, and/or gesture analysis that are similar to the corresponding functionalities discussed with reference to FIG. 4. The memory 504 may also store target information, such as tracked target information and/or predetermined recognizable target type information, as discussed in FIG. 4.

In some embodiments, the input device 506 receives user input to control one aspect of the movable object 102 (e.g., the zoom of the imaging device 214) while a control application generates the control instructions for adjusting another aspect of movable the object 102 (e.g., to control one or more movement characteristics of movable object 102). The control application includes, e.g., control module 402, tracking module 404 and/or a control application of control unit 104 and/or computing device 126. For example, input device 506 receives user input to control one or more movement characteristics of movable object 102 while the control application generates the control instructions for adjusting a parameter of imaging device 214. In this manner, a user is enabled to focus on controlling the navigation of movable object without having to provide input for tracking the target (e.g., tracking is performed automatically by the control application).

In some embodiments, allocation of tracking control between user input received at the input device 506 and the control application varies depending on factors such as, e.g., surroundings of the movable object 102, motion of the movable object 102, altitude of the movable object 102, system configuration (e.g., user preferences), and/or available computing resources (e.g., CPU or memory) of the movable object 102, the control unit 104, and/or the computing device 126. For example, relatively more control is allocated to the user when movable object is navigating in a relatively complex environment (e.g., with numerous buildings or obstacles or indoor) than when movable object is navigating in a relatively simple environment (e.g., wide open space or outdoor). As another example, more control is allocated to the user when the movable object 102 is at a lower altitude than when the movable object 102 is at a higher altitude. As a further example, more control is allocated to the movable object 102 if movable object 102 is equipped with a high-speed processor adapted to perform complex computations relatively quickly. In some embodiments, the allocation of control over the tracking process between the user and the movable object is dynamically adjusted based on one or more of the factors described herein.

FIG. 6 illustrates an exemplary computing device 126 for controlling movable object 102 according to some embodiments. The computing device 126 may be a server computer, a laptop computer, a desktop computer, a tablet, or a phone. The computing device 126 typically includes one or more processor(s) 602 (e.g., processing units), memory 604, a communication system 610 and one or more communication buses 612 for interconnecting these components. In some embodiments, the computing device 126 includes input/output (I/O) interfaces 606, such as a display 614 and/or an input device 616.

In some embodiments, the computing device 126 is a base station that communicates (e.g., wirelessly) with the movable object 102 and/or the control unit 104.

In some embodiments, the computing device 126 provides data storage, data retrieval, and/or data processing operations, e.g., to reduce the processing power and/or data storage requirements of movable object 102 and/or control unit 104. For example, computing device 126 is communicatively connected to a database (e.g., via communication 610) and/or computing device 126 includes database (e.g., database is connected to communication bus 612).

The communication system 610 includes one or more network or other communications interfaces. In some embodiments, the computing device 126 receives data from the movable object 102 (e.g., from one or more sensors of the movable object sensing system 122) and/or the control unit 104. In some embodiments, the computing device 126 transmits data to the movable object 102 and/or the control unit 104. For example, computing device provides control instructions to the movable object 102.

In some embodiments, the memory 604 stores instructions for performing image recognition, target classification, spatial relationship determination, and/or gesture analysis that are similar to the corresponding functionalities discussed with respect to FIG. 4. The memory 604 may also store target information, such as the tracked target information 408 and/or the predetermined recognizable target type information 414 as discussed in FIG. 4.

In some embodiments, the memory 604 or a non-transitory computer-readable storage medium of the memory 604 stores an application 620, which enables interactions with and control over the movable object 102, and which enables data (e.g., audio, video and/or image data) captured by the movable object 102 to be displayed, downloaded, and/or post-processed. The application 620 may include a user interface 630, which enables interactions between a user of the computing device 126 and the movable object 126. In some embodiments, the application 630 may include a video editing module 640, which enables a user of the computing device 126 to edit videos and/or images that have been captured by the movable object 102 during a flight associated with a target object 102, e.g., captured using the image sensor 216.

In some embodiments, the memory 604 also stores templates 650, which may be used for generating edited videos.

In some embodiments, the memory 604 also stores data 660 that have been captured by the movable object 102 during a flight associated with a target object 106, which include videos 661 that have been captured by the movable object 102 during a flight associated with a target object 106. In some embodiments, the data 660 may be organized according to flights 661 (e.g., for each flight route) by the movable object 102. The data for each of the flights 661 may include video data 662, images 663, and/or audio data 664. and/or. In some embodiments, the memory 604 further stores with the video data 662, the images 663, and the audio data 664 tag information 666 (e.g., metadata information). For example, the video data 662-1 corresponding to flight 1 661-1 may include tag information (e.g., metadata) that identifies the flight path and trajectory mode corresponding to the flight 661-1.

In some embodiments, the memory 604 also stores a web browser 670 (or other application capable of displaying web pages), which enables a user to communicate over a network with remote computers or devices.

Each of the above identified executable modules, applications, or sets of procedures may be stored in one or more of the memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 604 stores a subset of the modules and data structures identified above. Furthermore, the memory 604 may store additional modules or data structures not described above.

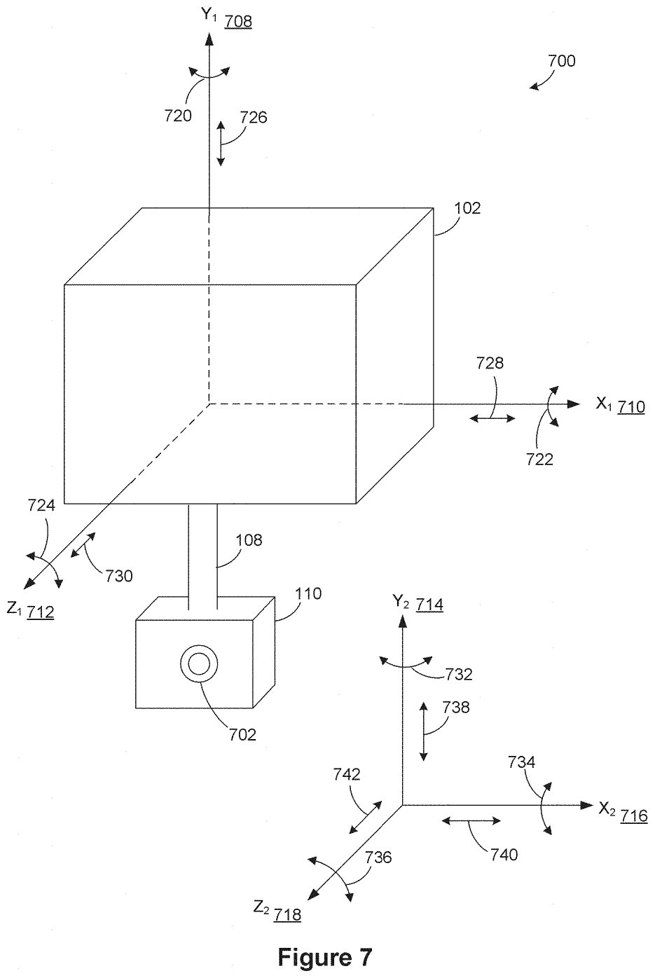

FIG. 7 illustrates an exemplary configuration 700 of a movable object 102, a carrier 108, and a payload 110 according to some embodiments. The configuration 700 is used to illustrate exemplary adjustments to an orientation, position, attitude, and/or one or more movement characteristics of the movable object 102, the carrier 108, and/or the payload 110, e.g., as used to perform initialization of target tracking and/or to track a target object 106.

In some embodiments, the movable object 102 rotates around up to three orthogonal axes, such as X1 (pitch) 710, Y1 (yaw) 708 and Z1 (roll) 712 axes. The rotations around the three axes are referred to herein as a pitch rotation 722, a yaw rotation 720, and a roll rotation 724, respectively. Angular velocities of the movable object 102 around the X1, Y1, and Z1 axes are referred to herein as ωX1, ωY1 and ωZ1, respectively. In some embodiments, the movable object 102 engages in translational movements 728, 726, and 730 along the X1, Y1, and Z1 axes, respectively. Linear velocities of the movable object 102 along the X1, Y1, and Z1 axes (e.g., velocities of the translational movements 728, 726, and 730) are referred to herein as VX1, VY1, and VZ1, respectively.

In some embodiments, the payload 110 is coupled to the movable object 102 via the carrier 108. In some embodiments, the payload 110 moves relative to the movable object 102 (e.g., the payload 110 is caused by the actuator 204 of the carrier 108 to move relative to the movable object 102).

In some embodiments, the payload 110 moves around and/or along up to three orthogonal axes, e.g., an X2 (pitch) axis 716, a Y2 (yaw) axis 714, and a Z2 (roll) axis 718. The X2, Y2, and Z2 axes are parallel to the X1, Y1, and Z1 axes respectively. In some embodiments, where the payload 110 includes the imaging device 214 (e.g., an optical module 702), the roll axis Z2 718 is substantially parallel to an optical path or optical axis for the optical module 702. In some embodiments, the optical module 702 is optically coupled to the image sensor 216 (and/or one or more sensors of the movable object sensing system 122). In some embodiments, the carrier 108 causes the payload 110 to rotate around up to three orthogonal axes, X2 (pitch) 716, Y2 (yaw) 714 and Z2 (roll) 718, e.g., based on control instructions provided to the actuator 204 of the carrier 108. The rotations around the three axes are referred to herein as the pitch rotation 734, yaw rotation 732, and roll rotation 736, respectively. The angular velocities of the payload 110 around the X2, Y2, and Z2 axes are referred to herein as ωX2, ωY2, and ωZ2, respectively. In some embodiments, the carrier 108 causes the payload 110 to engage in translational movements 740, 738, and 742, along the X2, Y2, and Z2 axes, respectively, relative to the movable object 102. The linear velocity of the payload 110 along the X2, Y2, and Z2 axes is referred to herein as VX2, VY2, and VZ2, respectively.

In some embodiments, the movement of the payload 110 may be restricted (e.g., the carrier 108 restricts movement of the payload 110, e.g., by constricting movement of the actuator 204 and/or by lacking an actuator capable of causing a particular movement).

In some embodiments, the movement of the payload 110 may be restricted to movement around and/or along a subset of the three axes X2, Y2, and Z2 relative to the movable object 102. For example, the payload 110 is rotatable around the X2, Y2, and Z2 axes (e.g., the movements 732, 734, 736) or any combination thereof, the payload 110 is not movable along any of the axes (e.g., the carrier 108 does not permit the payload 110 to engage in the movements 738, 740, 742). In some embodiments, the payload 110 is restricted to rotation around one of the X2, Y2, and Z2 axes. For example, the payload 110 is only rotatable about the Y2 axis (e.g., rotation 732). In some embodiments, the payload 110 is restricted to rotation around only two of the X2, Y2, and Z2 axes. In some embodiments, the payload 110 is rotatable around all three of the X2, Y2, and Z2 axes.

In some embodiments, the payload 110 is restricted to movement along the X2, Y2, or Z2 axis (e.g., the movements 738, 740, or 742), or any combination thereof, and the payload 110 is not rotatable around any of the axes (e.g., the carrier 108 does not permit the payload 110 to engage in the movements 732, 734, or 736). In some embodiments, the payload 110 is restricted to movement along only one of the X2, Y2, and Z2 axes. For example, movement of the payload 110 is restricted to the movement 740 along the X2 axis). In some embodiments, the payload 110 is restricted to movement along only two of the X2, Y2, and Z2 axes. In some embodiments, the payload 110 is movable along all three of the X2, Y2, and Z2 axes.

In some embodiments, the payload 110 is able to perform both rotational and translational movement relative to the movable object 102. For example, the payload 110 is able to move along and/or rotate around one, two, or three of the X2, Y2, and Z2 axes.

In some embodiments, the payload 110 is coupled to the movable object 102 directly without the carrier 108, or the carrier 108 does not permit the payload 110 to move relative to the movable object 102. In some embodiments, the attitude, position and/or orientation of the payload 110 is fixed relative to the movable object 102 in such cases.

In some embodiments, adjustment of attitude, orientation, and/or position of the payload 110 is performed by adjustment of the movable object 102, the carrier 108, and/or the payload 110, such as an adjustment of a combination of two or more of the movable object 102, the carrier 108, and/or the payload 110. For example, a rotation of 60 degrees around a given axis (e.g., yaw axis) for the payload is achieved by a 60-degree rotation by the movable object 102 alone, a 60-degree rotation by the payload relative to the movable object 102 as effectuated by the carrier, or a combination of 40-degree rotation by the movable object and a 20-degree rotation by the payload 110 relative to the movable object 102.

In some embodiments, a translational movement for the payload 110 is achieved via adjustment of the movable object 102, the carrier 108, and/or the payload 110 such as an adjustment of a combination of two or more of the movable object 102, carrier 108, and/or the payload 110. In some embodiments, a desired adjustment is achieved by adjustment of an operational parameter of the payload 110, such as an adjustment of a zoom level or a focal length of the imaging device 214.

FIG. 8 illustrates an exemplary operating environment 800 according to some embodiments. In some embodiments, and as illustrated in FIG. 8, the operating environment comprises a movable object 102, an electronic device 820, and a target object 106. The movable object 102 is communicatively connected to the electronic device 820 via communication network(s) 810. In some embodiments, the electronic device 820 is a user-operated device. The electronic device 820 may include one or more emitters 830. In some embodiments, the emitter 830 comprises one or more illumination sources, such as one or more illuminators, light sources, LEDs, structured light, laser lights, etc.) and is used to illuminate a target object 106. The emitter 830 may include a high intensity light source, and/or a spatially coherent light source, and/or a highly directional light source (e.g., with low diffusivity). In some embodiments, the emitter 830 may comprise one or more laser types, each of the laser types having a corresponding operational wavelength.

In some embodiments, a user may identify the target object 106 as an object of interest for UAV aerial photography and/or videography to be performed. In accordance with the identification of the target object 106, the user may direct illumination (e.g., a beam of light) using the emitter 830 toward the target object 106. In some embodiments, the user may also instruct the electronic device 820 to transmit a signal 812 (e.g., a wireless signal) to be transmitted to the movable object 102 via the communication network(s) 810. For example, the user may activate one or more input device(s) 910 (FIG. 9) on the electronic device 820, which causes the electronic device 820 to transmit the wireless signal 812 to the movable object 102. In some embodiments, the wireless signal 812 is transmitted directly from the electronic device 820 to the movable object 102. In some embodiments, the wireless signal 812 is transmitted from the electronic device 820 to the movable object 102 via the control unit 104 (see FIG. 1). In some embodiments, the electronic device 820 is configured to automatically transmit the wireless signal 812 to the movable object 102 in accordance with a determination that the emitter 830 has been activated. In some embodiments, the electronic device 820 and the movable object 102 are continuously communicating with each other. The electronic device 820 is configured to transmit signals to the movable object 102 at periodic intervals and/or whenever the emitter 830 is activated.

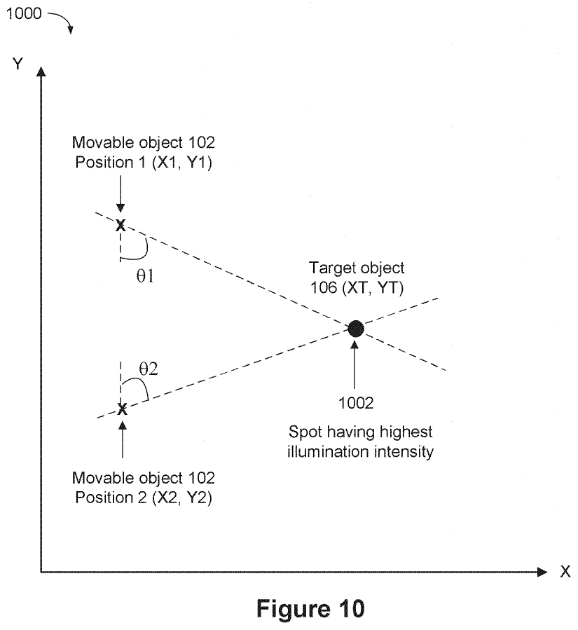

In some embodiments, the signal wireless signal 812 may include a direction of illumination 840 of the electronic device 820. In accordance with the wireless signal 812, the movable object 102 may identify the target object 106 based, at least in part, on the direction of illumination 840. In some embodiments, the movable object 102 may also determine the positional coordinates of the target object 106. This will be discussed in further detail in FIG. 10.

FIG. 9 is a block diagram illustrating a representative electronic device 820 according to some embodiments.

In some embodiments, the electronic device 820 includes one or more processor(s) 902, one or more communication interface(s) 904 (e.g., network interface(s)), memory 906, and one or more communication buses 908 for interconnecting these components (sometimes called a chipset).

In some embodiments, the electronic device 820 includes input device(s) 910 that facilitate user input and/or audio input. For example, the input device(s) 910 may include microphones, button(s) 918, and/or a touch sensor array.

In some embodiments, the electronic device 820 includes output device(s) 916 that facilitate visual output and/or audio output. The output device(s) 916 include the emitter(s) 830 that are described in FIG. 8. In some embodiments, the output device(s) 916 also include one or more speakers and/or a display 328.

In some embodiments, the electronic device 820 includes radios 920 and one or more sensors 930. The radios 920 enable one or more communication networks, and allow the electronic device 820 to communicate with other devices, such as the movable object 102. In some implementations, the radios 920 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, Ultrawide Band (UWB), software defined radio (SDR) etc.) custom or standard wired protocols (e.g., Ethernet, HomePlug, etc.), and/or any other suitable communication protocol, including communication protocols not yet developed as of the filing date of this document.

In some embodiments, the sensors 930 include one or more movement sensors (e.g., accelerometers), light sensors, time-of-flight (ToF) sensors, positioning sensors (e.g., GPS, inertial sensors (e.g., an inertial measurement unit or IMU), magnetometers, and/or audio sensors. In some implementations, the positioning sensors include one or more location sensors (e.g., passive infrared (PIR) sensors) and/or one or more orientation sensors (e.g., gyroscopes).

In some embodiments, the electronic device 820 includes a clock 912. In some embodiments, the clock 912 synchronizes (e.g., coordinates) time with the clock 152 of the movable object 102.

In some embodiments, the electronic device 820 includes a camera 914. The camera 914 includes a field of view and allows capture of images and/or video that includes the field of view.

The memory 906 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 906, optionally, includes one or more storage devices remotely located from one or more processor(s) 902. The memory 906, or alternatively the non-volatile memory within the memory 906, includes a non-transitory computer-readable storage medium. In some implementations, the memory 906, or the non-transitory computer-readable storage medium of the memory 906, stores the following programs, modules, and data structures, or a subset or superset thereof:
operating logic 932 including procedures for handling various basic system services and for performing hardware dependent tasks;
a radio communication module 934 for connecting to and communicating with other network devices (e.g., a local network, such as a router that provides Internet connectivity, networked storage devices, network routing devices, server systems movable object 102 etc.) coupled to one or more communication networks 810 via one or more communication interfaces 904 (wired or wireless);
positioning module 936 for determining a position (e.g., positional coordinates) of the electronic device 820; and
device data 938 for the electronic device 820, including but not limited to:
   device settings 3502 for the electronic device 820, such as default options and preferred user settings;
   camera data 942 (e.g., images and/or video data) that are captured by the camera 914; and
   illumination settings 944 for the emitter(s) 830, such as default options, temporal settings, and/or wavelength settings (e.g., when the emitter(s) include light sources with different wavelengths).

Each of the above identified modules are optionally stored in one or more of the memory devices described herein, and corresponds to a set of instructions for performing the functions described above. The above identified modules or programs need not be implemented as separate software programs, procedures, modules or data structures, and thus various subsets of these modules may be combined or otherwise re-arranged in various implementations. In some embodiments, the memory 906 stores a subset of the modules and data structures identified above. Furthermore, the memory 906, optionally, stores additional modules and data structures not described above (e.g., a microphone module for obtaining and/or analyzing audio signals in conjunction with microphone input devices, a module for voice detection and/or speech recognition in a voice-enabled smart speaker). In some embodiments, a subset of the programs, modules, and/or data stored in the memory 906 are stored on and/or executed by a server system (e.g., computing device 126).

As noted earlier in FIG. 8, in some embodiments, the electronic device 820 emits an illumination (e.g., a beam of light, a laser light etc.) using the emitter(s) 830. The electronic device 820 also transmits a signal (e.g., wireless signal 812) to the movable object 102. In some embodiments, the wireless signal 812 includes the direction of illumination 840. In some embodiments, in response to the wireless signal 812 that includes the direction of illumination 840, the movable object 102 is configured to determine the positional coordinates of the target object 106.

FIG. 10 illustrates an exemplary method 1000 performed by the movable object 102 to determine the positional coordinates of the target object 106 according to some embodiments.

In some embodiments, in accordance with receiving the wireless signal 812 that includes the direction of illumination 840, the movable object 102 may orient (e.g., reorient) one or more image sensors (e.g., the image sensor 216 and/or the image sensors 302) toward the direction of illumination 840. The movable object 102 may detect, from the field of view of the image sensors, a region 1002 that has the strongest illumination intensity, and/or a predefined illumination intensity, and/or an illumination intensity that is different from other regions of the field of view of the image sensors. The movable object may associate (e.g., identify) the region 1002 as corresponding to the target object 106.

In some embodiment, the region 1002 comprises a point of interest (e.g., a spot). In some embodiments, the region 1002 comprises a predefined number of pixels (e.g., 5 pixels, 7 pixels, 10 pixels) on the image sensors. In some embodiments, the image sensors may include a color filter array (e.g., an RGB filter array) for acquiring color images and the movable object 102 identifies the region 1002 according to R-channel (e.g., red) pixels that exhibit high intensity and are located adjacent to one another

Having identified the region 1002 as corresponding to the target object 106, the movable object 102 then determines the positional coordinates for the target object 106. In some embodiments, the movable object 102 performs ranging through the region 1002 (e.g., using a parallax method). For example, as illustrated in FIG. 10, the movable object 102 may situate (e.g., position) itself at position 1 (e.g., with global positional coordinates (X1, Y1)) and determine an angle θ1 between itself and the target object 106. Then the movable object 102 may situate (e.g., position) itself at position 2 (e.g., with global positional coordinates (X2, Y2)) and determine an angle θ2 between itself and the target object 106. Because the movable object 102 knows the coordinates (X1, Y1) and the coordinates (X2, Y2) (e.g., the movable object 102 can determine these coordinates using the GPS sensor that it is equipped), and knows the angles θ1 and θ2, the movable object 102 can determine the positional coordinates (e.g., (XT, YT) of the target object 106.

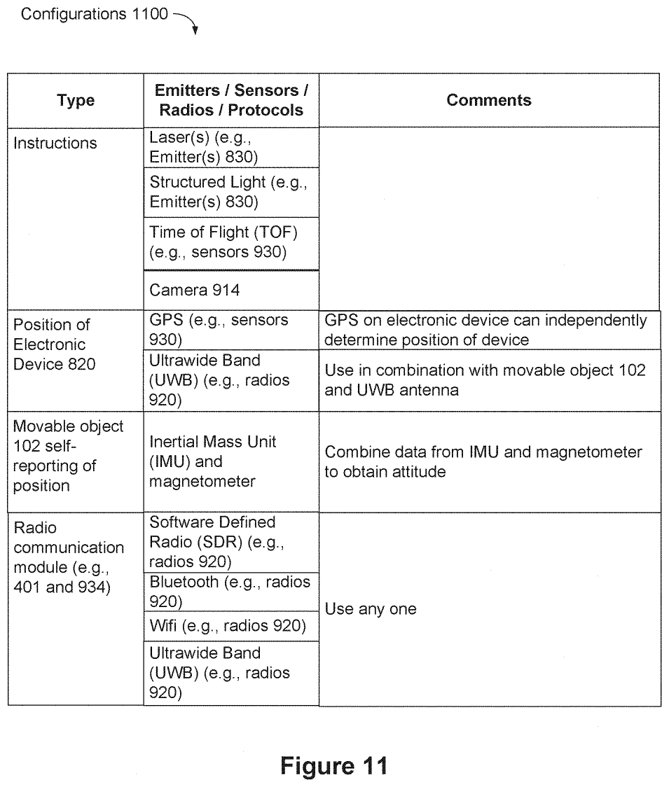

FIG. 11 illustrates exemplary configurations of the electronic device 820 and the movable object 102 for determining a position of a target object according to some embodiments.

In some embodiments, and as illustrated in FIG. 11, the electronic device 820 includes emitter(s) 830. The emitter(s) 830 may include laser(s) and/or structured light as illumination sources (e.g., light sources). The emitter(s) 830 emit illumination with high intensity, coherence, and/or directionality. In some embodiments, the laser(s) comprise different types with different wavelengths (e.g., color). For example, the laser(s) may include a red laser that utilizes a red laser diode near the 650 nm wavelength (e.g., 630 nm to 670 nm wavelength), and/or a green laser having a wavelength of around 510 nm to 570 nm, and/or a blue laser having a wavelength of roughly around 400 nm to 500 nm. In some embodiments, the wireless signal 812 that is transmitted to the movable object also includes information regarding the wavelength(s) (e.g., colors) of the illumination source(s).

In some embodiments, the emitter(s) 830 include a structured light that projects a predefined pattern of illumination (e.g., grids and/or bars with a known pitch and/or spacing, a barcode, a QR code etc.) on the target object 106. In some embodiments, the wireless signal 812 that is transmitted to the movable object 102 also includes information regarding the structured light, such as information about the known pattern, grid and/or bar spacing's etc., to facilitate accurate identification of the target object 106 by the movable object 102.

In some embodiments, the emitter(s) 830 emit light with a temporal frequency. For example, the emitter(s) may flash rhythmically (e.g., once every second, every three seconds, etc.). In some embodiments, the signal 812 further includes a temporal frequency of the illumination.

In some embodiments, and as illustrated in FIG. 11, the electronic device 820 includes a time-of-flight (ToF) sensor (e.g., ToF camera) (e.g., sensors 930) that determines a distance between the electronic device 820 and the target object 106. In some embodiments, the wireless signal 812 includes the distance between the electronic device 820 and the target object 106, and also includes the position of the electronic device 820. In some embodiments, the movable object 102 determines the position (e.g., positional coordinates) of the target object 106 in accordance with the distance between the electronic device 820 and the target object 106 and the position of the electronic device 820.

In some embodiments, the electronic device 820 captures an image of the target object 106 using the camera 914. The wireless signal 812 includes the image of the target object 106. The movable object 102 is configured to identify the target object (e.g., by matching the captured image with images that are captured with the image sensors of the movable object 102).

In some embodiments, the electronic device 820 may determine its own position and transmit information of its position to the movable device 102 (e.g., the position of the electronic device 102 is included in the wireless signal 802). In some embodiments, and as illustrated in FIG. 11, the electronic device 820 may include a positioning sensor (e.g., a GPS, sensors 930) that can independently determine the position of the electronic device 820. In some embodiments, the electronic device 820 may utilize an ultra-wide band (UWB) (e.g. via radios 920) in combination with the movable object 102 (e.g., the positioning sensor of the movable object to determine the position of the electronic device 820.

In some embodiments, and as illustrated in FIG. 11 and FIG. 9, the electronic device 820 includes a radio communication module 934 for connecting to and communicating with the movable object 102 (e.g., via SDR, Bluetooth, Wi-Fi, UWB).

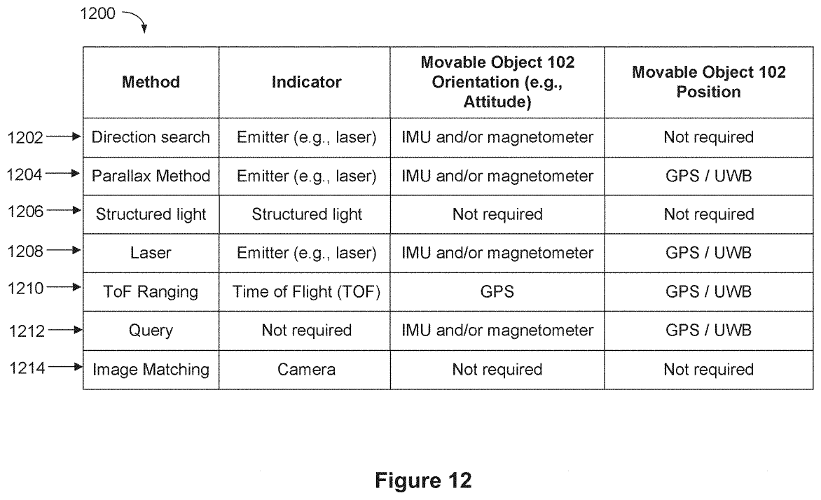

FIG. 12 illustrates exemplary methods 1200 that a movable object 102 may use to determine a position of a target object 106, and corresponding information (e.g., attitude and/or position of the movable object 102) that are provided by the movable object 102, according to some embodiments. In some embodiments, and as illustrated in FIG. 12, the methods 1200 include a direction search method 1202, a parallax method 1204, a structured light method 1206, a laser method 1208, a ToF ranging method 1210, a query method 1212, and an image matching method 1214.

For example, referring to FIG. 12, when the direction search method 1202 is used, the electronic device 820 transmits to the movable object 102 a signal (e.g., wireless signal 812) that includes information regarding illumination from the emitter(s) 830 (e.g., a direction of illumination, and/or a temporal frequency of the illumination, and/or a wavelength of the illumination). The movable object 102 combines the wireless signal 812 with information about its own orientation (e.g., attitude) that is determined by an inertial mass unit (IMU) (e.g., inertial sensors) and/or a magnetometer of the movable object 102 (e.g., the movable object sensing system 122), to determine a position of the target object 106. As further noted in FIG. 12, in the direction search method 1202, the movable object 102 does not utilize information about its own position to determine the position of the target object.

In some embodiments, the movable object 102 uses a parallax method 1204 to determine a position of the target object 106. The details of the parallax method 1204 are described with respect to FIG. 10 and will not be repeated for the sake of brevity.

Referring again to FIG. 12, the methods 1200 include the structured light method 1206. In the structured light method 1206, the electronic device 820 transmits to the movable object 102 a wireless signal that comprises a predefined pattern of illumination. For example, the emitter(s) 830 may cast (e.g., illuminate, shine, direct) a predefined pattern of illumination on the target object 106. The electronic device 820 transmits a wireless signal 812 that includes the predefined pattern of illumination. The movable object 102 identifies from the field of view of the image sensors the predefined pattern of illumination, and locates the target object 106 accordingly. The movable object 102 does not require information about its own orientation, or information about its own position, to determine the positional coordinates of the target object 106.

The methods 1200 include the laser method 1208. In the laser method 1208, the electronic device 820 directs illumination on the target object 106. The electronic device 820 determines a distance between the electronic device 820 and the target object 106. The electronic device 820 also determine its own position (e.g., its own positional coordinates) and/or orientation (e.g., via a GPS, sensors 930). The electronic device 820 transmits to the movable object a wireless signal that includes the direction of illumination, information of the distance between the electronic device 820 and the target object 106 and information about the position of the electronic device 820. In some embodiments, in response to the wireless signal, the movable object 102 orients the image sensors (e.g., image sensors 216) toward the direction of illumination, and identifies the target object in accordance with the direction of illumination, the information of the distance between the electronic device 820 and the target object 106, and the information about the position of the electronic device 820.

In some embodiments, and as illustrated in FIG. 12, the methods 1200 include the ToF ranging method 1210. As discussed with reference to FIG. 11, in some embodiments, the electronic device 820 includes a time-of-flight (ToF) sensor (e.g., a ToF camera) that determines a distance between the electronic device 820 and the target object 106 by illuminating the target object (e.g., using emitter(s) 830). In some embodiments, the emitter(s) 830 illuminate the target object 106 at regular, predefined time intervals, and the time of illumination is determined using the clock 912 of the electronic device 820. The electronic device 820 may transmit to the movable object 102 signals that include the distance between the electronic device 820 and the target object 106, and the position of the electronic device 820. The electronic device 820 may also transmit to the movable device the precise times at which the target object 106 is illuminated. In some embodiments, the movable object 102 can determine, based on the signals and its own position, a distance between the movable object 102 and the electronic device 820. The movable object 102 can also determine (e.g., using the clock 152 of the movable object 102 that is synchronized with the clock 912 of the electronic device 820) a time difference between the time at which the emitter(s) 830 illuminate the target object 106 and the time at which the movable object 102 detects the illumination (e.g., using the sensors 302 and/or the sensor 216). The movable object 102 can then determine the position of the target object 106 using the distance between the electronic device 802 and the target object 106, the distance between the movable object 102 and the target object 106, the position of the electronic device 820, and information about its own position.

The methods 1200 also include a query method 1212. In some embodiments, the electronic device 820 transmits to the movable object 102 a wireless signal that includes a direction of illumination. In response to wireless signal, the movable object 102 accesses (e.g., downloads, or retrieves from the memory 118) a map that corresponds to the direction of illumination and in accordance with the positional coordinates of the movable object 102. The movable object 102 identifies from the map the target object 106. For example, the movable device 102 may identify the first structure (e.g., a building) on the map that is nearest to the movable object 102 and corresponding to the direction of illumination as the target object 106. In some circumstances, the movable object 102 may determine that an object on the map that is nearest to the movable device and that corresponds to the direction of illumination is an obstacle. In this situation, the movable object 102 may identify an object that is next to (e.g., behind) the obstacle as the first object

The methods 1200 further include an image matching method 1214. In some embodiments, the electronic device 820 includes a camera 914. The electronic device 820 captures an image that includes the target object 106 using the camera 914. The movable object 102 determines the target object 106 according to a match between objects in the video data and the image.

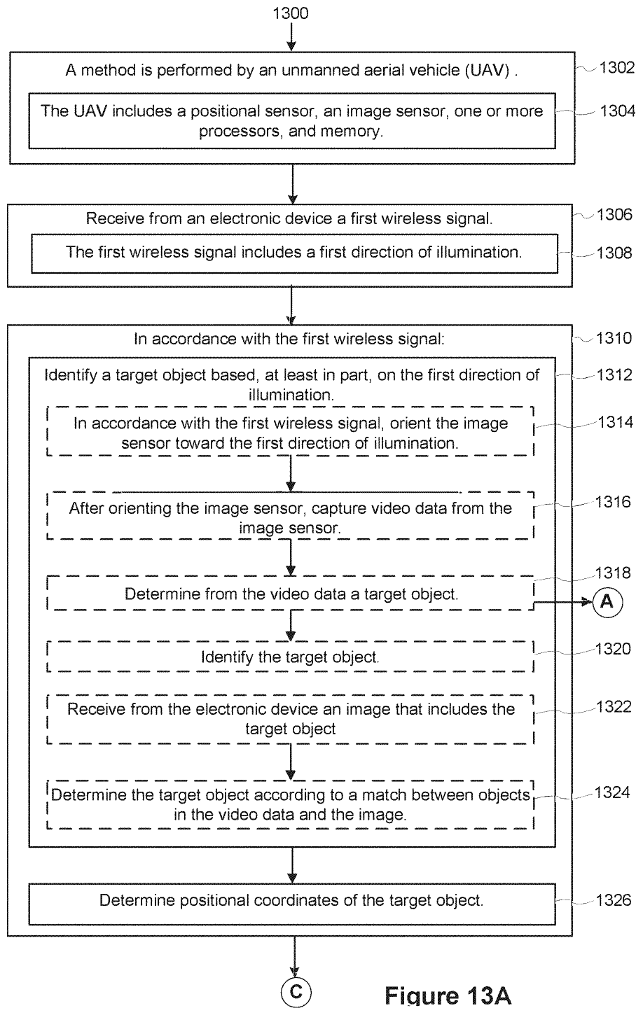

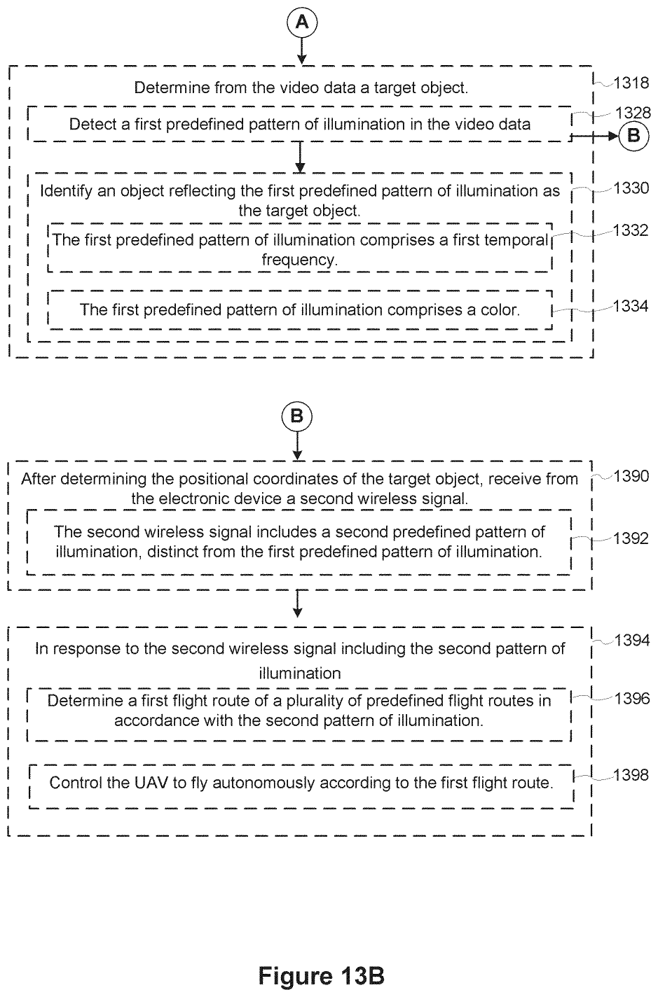

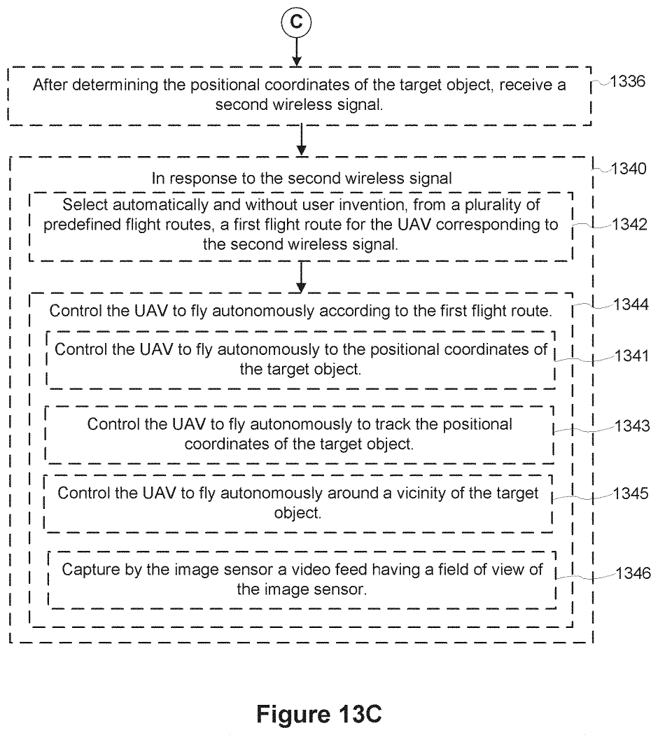

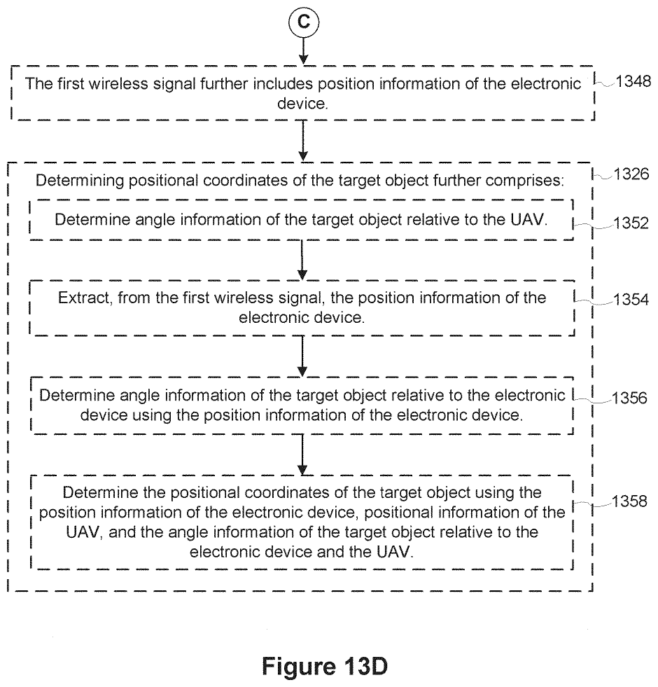

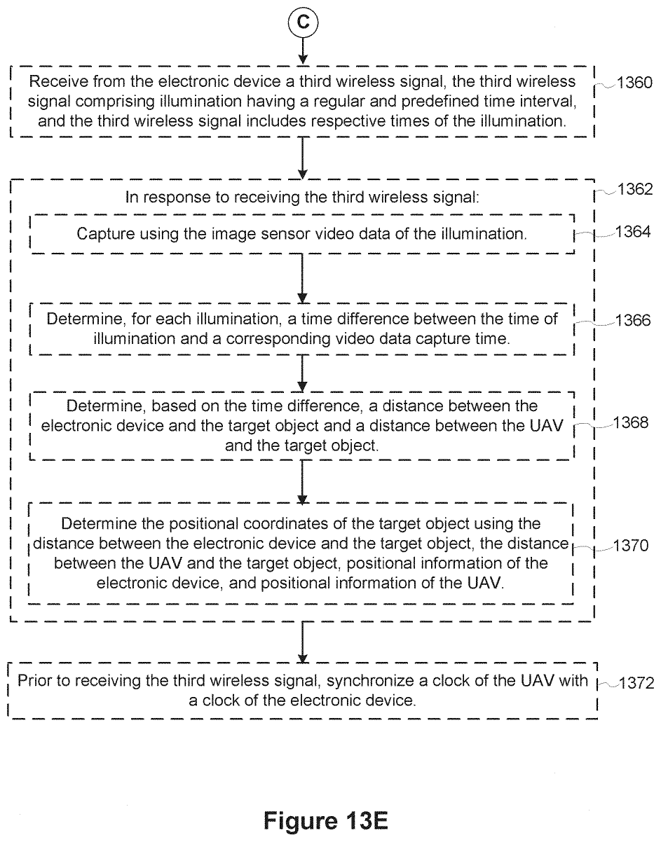

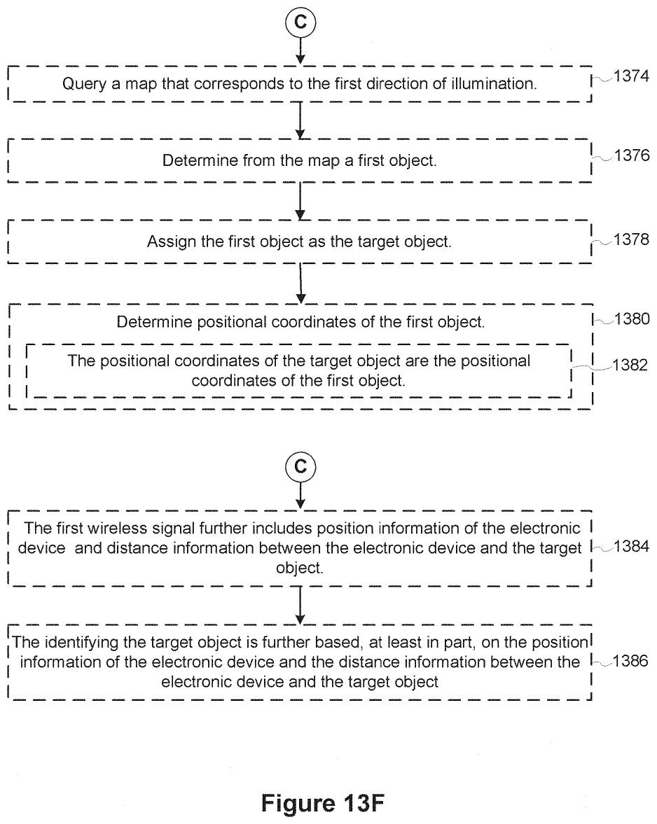

FIGS. 13A-13F provide a flowchart of a method 1300 according to some embodiments.

The method 1300 is performed (1302) at an unmanned aerial vehicle (UAV) (e.g., movable object 102).

The UAV includes (1304) having a positional sensor (e.g., a GPS sensor, movable object sensing system 122, FIG. 2A), an image sensor (e.g., image sensor image sensors 302 and/or image sensor 216), one or more processors (e.g., processor(s) 116), and memory (e.g., memory 118).

The UAV receives (1306) from an electronic device a first wireless signal.

The first wireless signal includes (1308) a first direction of illumination.

For example, referring to FIG. 8, the UAV (movable object 102) is communicatively connected to the electronic device 820 via communication network(s) 810. The electronic device 820 includes emitter(s) 830. The UAV receives from the electronic device 820 a wireless signal 812. The wireless signal 812 includes a direction of illumination 840.

In accordance with (1310) the first wireless signal, the UAV identifies (1312) a target object (e.g., target object 106) based, at least in part, on the first direction of illumination.

In some embodiments, identifying a target object based, at least in part, on the first direction of illumination further comprises: in accordance with (1314) the first wireless signal, the UAV orients the image sensor toward the first direction of illumination. After orienting the image sensor, the UAV captures (1316) (e.g., obtains) video data via the image sensor. The UAV determines (1318) from the video data a target object. The UAV identifies (1312) the target object accordingly.

For example, referring to FIG. 10, in some embodiments, in accordance with the wireless signal 812, the movable object 102 orients the image sensors 302 and/or the image sensor 216 toward the direction of illumination 840. After orienting the image sensors 302 and/or the image sensor 216, the movable object 102 captures video data via the image sensors 302 and/or the image sensor 216. The movable object 102 determines from the video data a target object 106. In some embodiments, the movable object 102 may associate a region 1002 in the image sensor that detects the strongest illumination intensity as corresponding to the target object 106.

In some embodiments, the operation (e.g., step, process) of determining (1318) from the video data the target object further comprises: the UAV receives (1322) from the electronic device an image that includes the target object. The UAV determines (1324) the target object according to a match between objects in the video data and the image.

For example, referring to FIGS. 9, 11, and 12 (e.g., image matching method 1214), in some embodiments, the electronic device 820 includes a camera 914. The electronic device 820 captures an image that includes the target object 106 using the camera 914. The movable object 102 determines the target object 106 according to a match between objects in the video data and the image.

The method 1300 further comprises: the UAV determines (1326) positional coordinates of the target object.

In some embodiments, the operation (e.g., step, process) of determining (1318) from the video data the target object comprises: the UAV detects (1328) a first predefined pattern of illumination in the video data. The UAV identifies (1330) an object reflecting the first predefined pattern of illumination as the target object.

For example, as described in FIGS. 11 and 12, in some embodiments, the emitter(s) 830 comprise structured light that projects a first predefined pattern of illumination (e.g., grids and/or bars with a known pitch and/or spacing, a barcode, a QR code etc.) on the target object 106. In some embodiments, the first wireless signal includes information regarding the first predefined pattern of information. The movable object 102 detects from the video data the first predefined pattern of illumination, and identifies from the video data an object reflecting the first predefined pattern of illumination as the target object 106.

In some embodiments, the first predefined pattern of illumination comprises (1332) a first temporal frequency.

For example, in some embodiments, the emitter(s) 830 may comprise laser light and/or structured light that flashes (e.g., blinks) rhythmically at the first temporal frequency. In some embodiments, the wireless signal 812 that includes the direction of illumination 840 also includes information regarding the first temporal frequency. The UAV may determine an object as the target object 106 based on a match between information regarding the first temporal frequency that is included in the wireless signal 812 and the temporal frequency of the predefined pattern of illumination that is captured in the video data. In some embodiments, the information about the illumination itself (e.g., a temporal frequency of illumination and/or the pattern of illumination) that is provided in the wireless signal 812 (e.g., structured light method 1206 and/or laser method 1208, FIG. 12) allows the UAV to distinguish (and disregard) signals (e.g., illumination) that are transmitted by other electronic devices and intended for other movable objects. In some embodiments, the electronic device 820 may be configured to operate at different predefined temporal frequencies. For example, each of the different predefined temporal frequencies may correspond to a different (e.g., unique or specific) instruction from the electronic device 820 to the UAV. For instance, the first temporal frequency may comprise an instruction to the UAV to determine the positional coordinates of the target object 106. After determining the positional coordinates of the target object, the electronic device 820 may send another wireless signal that comprises a second temporal frequency of illumination. The second temporal frequency of illumination may comprise an instruction to the UAV to execute a specific flight path (e.g., flight routes 416). In some embodiments, the first temporal frequency of illumination may comprise an instruction to the UAV to determine the positional coordinates of the target object 106 as well as execute a flight route (e.g., a default flight route) toward the target object 106.

In some embodiments, the first predefined pattern of illumination comprises (1334) a color.

For example, in some embodiments, the emitter(s) 830 include a plurality of light sources each having a corresponding wavelength. The first predefined pattern of illumination may comprise a predefined wavelength that produces a corresponding spectral color. In some embodiments, the emitter(s) 830 may be configured to emit light at different predefined wavelengths. For example, the emitter(s) 830 may comprise different types of lasers with different wavelengths, thereby producing different colors. In some embodiments, the wireless signal 812 that includes a first direction of illumination 840 further includes information regarding the color of illumination. The UAV may determine an object as the target object based on a match between the information regarding the color that is included in the first wireless signal and the color that is captured in the video data.

In some embodiments, the color matching enables the UAV to distinguish (and disregard) signals that are transmitted by other electronic devices that are intended for other movable objects. In some embodiments, the electronic device 820 may be configured to operate at different colors (e.g., wavelengths). For example, in some embodiments, the emitter(s) 830 comprise different types of lasers with different wavelengths (e.g., colors). Each of the wavelengths (e.g., colors) corresponds to a different (e.g., unique or specific) instruction from the electronic device to the UAV. For example, the first wavelength (e.g., corresponding to a first color) may comprise an instruction to the UAV to determine the positional coordinates of the target object. After determining the positional coordinates of the target object, the electronic device may send another wireless signal that comprises a second predefined wavelength (e.g., corresponding to a second color). The second temporal wavelength may comprise an instruction to the UAV to execute a specific flight path (e.g., (e.g., flight routes 416).

In some embodiments, after determining the positional coordinates of the target object, the UAV receives (1390) from the electronic device 820 a second signal. The second wireless signal includes (1392) a second predefined pattern of illumination, distinct from the first predefined pattern of illumination. In some embodiments, the second predefined pattern of illumination includes a second temporal frequency that is distinct from the first temporal frequency. In response to (1394) the second wireless signal including the second pattern of illumination, the UAV determines (1396) a first flight route of a plurality of predefined flight routes in accordance with the second pattern of illumination. The UAV controls (1398) the UAV to fly autonomously according to the first flight route.

In some embodiments, the UAV stores mapping relationships between signals (e.g., wireless signals) and their corresponding instructions for the UAV. This is illustrated in FIG. 4B (e.g., mapping data 434). For example, in some embodiments, the electronic device 820 may transmit a wireless signal that includes a specific temporal frequency and/or a predefined pattern of illumination and/or a color (e.g., wavelength), which is mapped to a specific corresponding instruction for the UAV, such as an instruction to execute a specific flight route.

In some embodiments, after determining the positional coordinates of the target object, the UAV receives (1336) a second wireless signal. In some embodiments, the UAV receives the second wireless signal from the electronic device 820. In some embodiments, the UAV receives the second wireless signal from the control unit 104. In some embodiments, the second wireless signal comprises an instruction to execute a flight route for the UAV. In response to (1340) the second wireless signal, the UAV (1342) selects automatically and without user disclosure, from a plurality of predefined flight routes, a first flight route for the UAV corresponding to the second wireless signal. The one or more processors of the UAV control (1344) the UAV to fly autonomously according to the first flight route. In some embodiments, controlling the UAV to fly autonomously according to the first flight route comprises controlling (1341) the UAV to fly autonomously to the positional coordinates of the target object. In some embodiments, controlling the UAV to fly autonomously according to the first flight route comprises controlling (1343) the UAV to fly autonomously to track the positional coordinates of the target object. In some embodiments, controlling the UAV to fly autonomously according to the first flight route comprises controlling (1345) the UAV to fly autonomously around a vicinity of the target object.

In some embodiments, the first flight route comprises flying directly to the target object. In some embodiments, the first flight route comprises a route that includes the UAV surrounding the target object as it approaches the target object. In some embodiments, the target object is a moving object and the first flight route comprises instructions for the UAV to follow the moving target object.

In some embodiments, controlling the UAV to fly autonomously according to the first flight route includes capturing (1346) by the image sensor (e.g., image sensor 216) a video feed having a field of view of the image sensor.

In some embodiments, the first wireless signal further includes (1348) position information of the electronic device. The operation (e.g., step, process) of determining (1326) the positional coordinates of the target object further comprises: the UAV determines (1352) angle information of the target object relative to the UAV. The UAV extracts (1354), from the first wireless signal, the position information of the electronic device. The UAV determines (1356) angle information of the target object relative to the electronic device using the position information of the electronic device. The UAV also determines (1358) the positional coordinates of the target object using the position information of the electronic device, positional information of the UAV (e.g., using a positional sensor of the UAV, such as a GPS sensor), and the angle information of the target object relative to the electronic device and the UAV.

In some embodiments, the operation (e.g., step, process) of determining (1326) positional coordinates of the target object further comprises: the UAV receives (1360) from the electronic device a third wireless signal. The third wireless signal comprises illumination having a regular, predefined time interval (e.g., every one second, every three seconds, every five seconds etc.). The third wireless signal includes respective times of the illumination. In some embodiments, the electronic device includes a clock that determines a time of illumination and transmits the information regarding the time of illumination to the UAV. In response to (1362) receiving the third wireless signal, the UAV captures (1364) using the image sensor video data of the illumination. The UAV determines (1366), for each illumination, a time difference between the time of illumination and a corresponding video data capture time. The UAV determines (1368), based on the time difference, a distance between the electronic device and the target object and a distance between the UAV and the target object. The UAV determines (1370) the positional coordinates of the target object using the distance between the electronic device and the target object, the distance between the UAV and the target object, positional information of the electronic device, and positional information of the UAV. This is illustrated in the ToF ranging method 1210 in FIG. 12.

In some embodiments, prior to receiving the third wireless signal, the UAV synchronizes (1372) a clock of the UAV (e.g., clock 152) with a clock of the electronic device (e.g., clock 912).

In some embodiments, the operation (e.g., step, process) of determining the positional coordinates of the target object further comprises: the UAV queries (1374) a map that corresponds to the first direction of illumination. The UAV determines (1376) from the map a first object. The UAV assigns (1378) the first object as the target object. The UAV also determines (1380) positional coordinates of the first object. The positional coordinates of the target object are (1382) the positional coordinates of the first object.

In some embodiments, the UAV is configured to obtain (e.g., from the computing device 126) a map corresponding to its vicinity according to a position of the UAV (e.g., determined by the positional sensors). In some embodiments, the first object may be the nearest object in the first direction of illumination. In some embodiments, the UAV may determine that the nearest object is an obstacle, and determines an object next to (e.g., behind) the obstacle as the first object.

In some embodiments, the first wireless signal further includes (1384) position information of the electronic device 820 (e.g., determined from the sensors 930 of the electronic device 820) and distance information between the electronic device 820 and the target object 106. The identifying the target object 106 is further based (1386), at least in part, on the position information of the electronic device and the distance information between the electronic device and the target object.

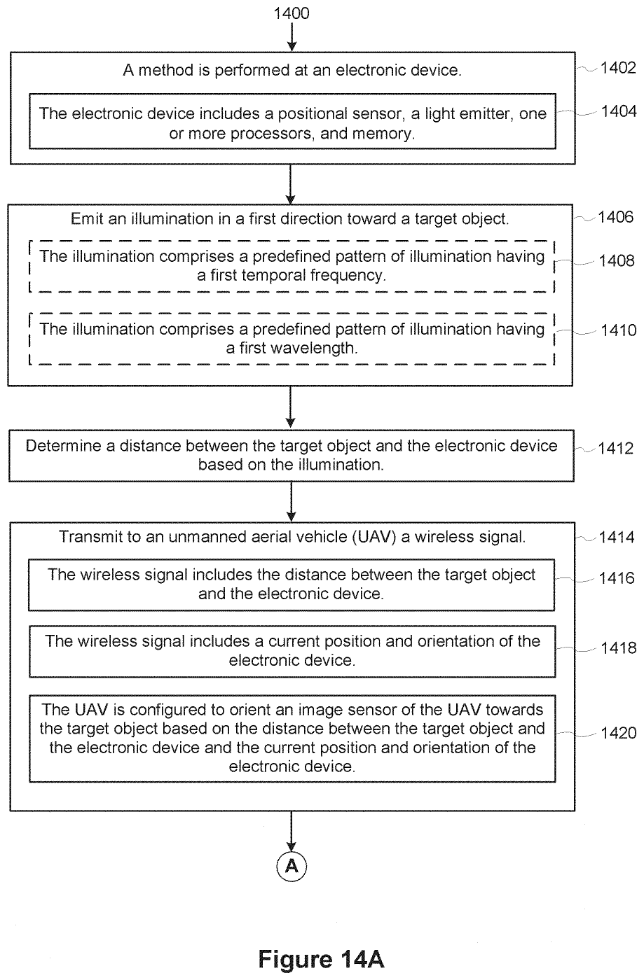

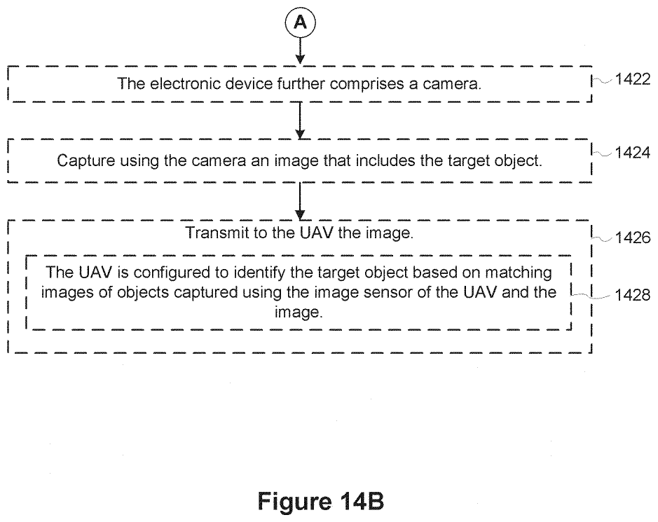

FIGS. 14A and 14B provide a flowchart of a method 1400 according to some embodiments.

The method 1400 is performed (1402) at an electronic device (e.g., electronic device 820).

The electronic device includes (1404) a positional sensor (e.g., sensors 930), a light emitter (e.g., emitter(s) 830), one or more processors (e.g., processor(s) 902), and memory (e.g., memory 906).

The electronic device 820 emits (1406) an illumination in a first direction (e.g., direction 840) toward a target object (e.g., target object 106). For example, as described with reference to FIGS. 8, 9, 11, and 12, the illumination may comprise illumination (e.g., light) with high intensity, and/or spatially coherent, and/or highly directional. In some embodiments, the emitter(s) 830 emit illumination with different predefined wavelengths thereby resulting in different spectral colors. The emitter(s) 830 may also emit light at different temporal frequencies.

In some embodiments, the illumination comprises (1408) a predefined pattern of illumination having a first temporal frequency.

For example, in some embodiments, the emitter(s) 830 may comprise laser light and/or structured light that flashes (e.g., blinks) rhythmically at the first temporal frequency. In some embodiments, each of the different predefined temporal frequencies may correspond to a different (e.g., unique or specific) instruction from the electronic device 820 to the movable object 102. For instance, the first temporal frequency may comprise an instruction to the UAV to determine the positional coordinates of the target object 106. After determining the positional coordinates of the target object, the electronic device 820 may send another wireless signal that comprises a second temporal frequency of illumination. The second temporal frequency of illumination may comprise an instruction to the movable object 102 to execute a specific flight path (e.g., flight routes 416).

In some embodiments, the illumination comprises (1410) a predefined pattern of illumination having a first wavelength (e.g., color). For example, in some embodiments, the emitter(s) 830 include a plurality of light sources each having a corresponding wavelength. The first predefined pattern of illumination may comprise a predefined wavelength that produces a corresponding spectral color. In some embodiments, the emitter(s) 830 may be configured to emit light at different predefined wavelengths. For example, the emitter(s) 830 may comprise different types of lasers with different wavelengths, thereby producing different colors.

The electronic device determines (1412) a distance between the target object and the electronic device based on the illumination.

The electronic device transmits (1414) to an unmanned aerial vehicle (UAV) (e.g., movable object 102) a wireless signal. The wireless signal includes (1416) the distance between the target object and the electronic device. The wireless signal also includes (1418) a current position and orientation of the electronic device. The UAV is configured to (1420) orient an image sensor of the UAV towards the target object based on the distance between the target object and the electronic device, and the current position and orientation of the electronic device.

In some embodiments, the electronic device further comprises (1422) a camera. The electronic device captures (1424) using the camera an image that includes the target object. The electronic device transmits (1424) to the UAV the image. The UAV is configured to (1428) identify the target object based on matching images of objects captured using the image sensor of the UAV and the image.

Many features of the present disclosure can be performed in, using, or with the assistance of hardware, software, firmware, or combinations thereof. Consequently, features of the present disclosure may be implemented using a processing system. Exemplary processing systems (e.g., processor(s) 116, controller 210, controller 218, processor(s) 502 and/or processor(s) 602) include, without limitation, one or more general purpose microprocessors (for example, single or multi-core processors), application-specific integrated circuits, application-specific instruction-set processors, field-programmable gate arrays, graphics processing units, physics processing units, digital signal processing units, coprocessors, network processing units, audio processing units, encryption processing units, and the like.

Features of the present disclosure can be implemented in, using, or with the assistance of a computer program product, such as a storage medium (media) or computer readable medium (media) having instructions stored thereon/in which can be used to program a processing system to perform any of the features presented herein. The storage medium (e.g., (e.g. memory 118, 504, 604) can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Communication systems as referred to herein (e.g., communication systems 120, 510, 610) optionally communicate via wired and/or wireless communication connections. For example, communication systems optionally receive and send RF signals, also called electromagnetic signals. RF circuitry of the communication systems convert electrical signals to/from electromagnetic signals and communicate with communications networks and other communications devices via the electromagnetic signals. RF circuitry optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Communication systems optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A method performed at an unmanned aerial vehicle (UAV) having a positional sensor and an image sensor, the method comprising:
receiving from an electronic structure a first wireless signal, the first wireless signal including a first direction of illumination;
in accordance with the first wireless signal:
identifying a target object based, at least in part, on the first direction of illumination; and
determining positional coordinates of the target object.

2. The method of claim 1, wherein the identifying the target object based, at least in part, on the first direction of illumination further comprises:
in accordance with the first wireless signal:
orienting the image sensor toward the first direction of illumination;
after orienting the image sensor, obtaining video data from the image sensor;
determining from the video data the target object; and
identifying the target object.

3. The method of claim 2, wherein the determining from the video data the target object further comprises:
receiving from the electronic structure an image that includes the target object; and
determining the target object according to a match between objects in the video data and the image.

4. The method of claim 2, wherein the determining from the video data the target object includes:
detecting a first predefined pattern of illumination in the video data; and
identifying an object reflecting the first predefined pattern of illumination as the target object.

5. The method of claim 4, wherein the first predefined pattern of illumination comprises a first temporal frequency.

6. The method of claim 4, wherein the first predefined pattern of illumination comprises a color.

7. The method of claim 4, further comprising:
after determining the positional coordinates of the target object, receiving from the electronic structure a second signal, the second signal including a second predefined pattern of illumination, distinct from the first predefined pattern of illumination;
in response to the second wireless signal including the second predefined pattern of illumination:
determining a first flight route of a plurality of predefined flight routes in accordance with the second pattern of illumination; and
controlling the UAV to fly autonomously according to the first flight route.

8. The method of claim 1, further comprising:
after determining the positional coordinates of the target object, receiving a second wireless signal; and
in response to the second wireless signal:
selecting automatically and without user intervention, from a plurality of predefined flight routes, a first flight route for the UAV corresponding to the second wireless signal;
controlling the UAV to fly autonomously according to the first flight route.

9. The method of claim 8, wherein the controlling the UAV to fly autonomously according to the first flight route comprises one or more of:
controlling the UAV to fly autonomously to the positional coordinates of the target object;
controlling the UAV to fly autonomously to track the positional coordinates of the target object; and
controlling the UAV to fly autonomously around a vicinity of the target object.

10. The method of claim 8, wherein the controlling the UAV to fly autonomously according to the first flight route includes capturing by the image sensor a video feed having a field of view of the image sensor.

11. The method of claim 1, wherein:
the first wireless signal further includes position information of the electronic structure; and
the determining positional coordinates of the target object further comprises:
determining angle information of the target object relative to the UAV;
determining angle information of the target object relative to the electronic structure using the position information of the electronic structure; and
determining the positional coordinates of the target object using the position information of the electronic structure, positional information of the UAV, and the angle information of the target object relative to the electronic structure and the UAV.

12. The method of claim 1, wherein the determining positional coordinates of the target object further comprises:
receiving from the electronic structure a third wireless signal, the third wireless signal comprising illumination having a regular and predefined time interval, and the third wireless signal includes respective times of the illumination;
in response to receiving the third wireless signal:
capturing video data of the illumination using the image sensor;
determining, for each illumination, a time difference between the time of illumination and a corresponding video data capture time;
determining, based on the time difference, a distance between the electronic structure and the target object and a distance between the UAV and the target object; and
determining the positional coordinates of the target object using the distance between the electronic structure and the target object, the distance between the UAV and the target object, positional information of the electronic structure, and positional information of the UAV.

13. The method of claim 12, further comprising:
prior to receiving the third wireless signal, synchronizing a clock of the UAV with a clock of the electronic structure.

14. The method of claim 1, wherein the determining positional coordinates of the target object further comprises:
querying a map that corresponds to the first direction of illumination;
determining from the map a first object;
assigning the first object as the target object; and
determining positional coordinates of the first object;
wherein the positional coordinates of the target object are the positional coordinates of the first object.

15. The method of claim 1, wherein:
the first wireless signal further includes position information of the electronic structure and distance information between the electronic structure and the target object; and
the identifying the target object is further based, at least in part, on the position information of the electronic structure and the distance information between the electronic structure and the target object.

16. A method performed at an electronic device having a positional sensor and a light emitter, the method comprising:
emitting an illumination in a first direction toward a target object;
determining a distance between the target object and the electronic device based on the illumination; and
transmitting to an unmanned aerial vehicle (UAV) a wireless signal, the wireless signal including the distance between the target object and the electronic device and including a current position and orientation of the electronic device, wherein the UAV is configured to orient an image sensor of the UAV towards the target object based on the distance between the target object and the electronic device and the current position and—orientation of the electronic device.

17. The method of claim 16, wherein the illumination comprises a predefined pattern of illumination having a first temporal frequency.

18. The method of claim 16, wherein the illumination comprises a predefined pattern of illumination having a first wavelength.

19. The method of claim 16, wherein the electronic device further comprises a camera, the method further comprising:
capturing using the camera an image that includes the target object; and
transmitting to the UAV the image;
wherein the UAV is configured to identify the target object based on matching images of objects captured using the image sensor of the UAV and the image.

20. An unmanned aerial vehicle (UAV), further comprising:
one or more processors; and
memory coupled to the one or more processors, the memory storing one or more programs configured to be executed by the one or more processors, the one or more programs including instructions for performing the method of claim 1.
